(19) United States
(12) Patent Application Publication
(10) Pub. No.: US 2019/0163664 A1
(43) Pub. Date: May 30, 2019

(54) METHOD AND SYSTEM FOR INTELLIGENT PRIMING OF AN APPLICATION WITH RELEVANT PRIMING DATA

(71) Applicant: salesforce.com, inc., San Francisco, CA (US)

(72) Inventors: VIJAY KARANI, SARATOGA, CA (US); PRASHANTH MADISETTI, AUSTIN, TX (US); JAYANT TYAGI, UNION CITY, CA (US)

(73) Assignee: salesforce.com, inc., San Francisco, CA (US)

(21) Appl. No.: 15/823,079

(22) Filed: Nov. 27, 2017

(51) Int. Cl. G06F 15/173; G06N 99/00; G06F 17/30

(52) U.S. Cl. CPC G06F 15/17331; G06F 17/3053; G06N 99/005

(57) ABSTRACT

Methods and systems are provided for intelligent priming. An Intelligent Priming Module (IPM) can process various input parameters to determine relevant priming data for priming an application at a user system. The relevant priming data is predicted to be relevant to a particular user and user system based on one or more of the input parameters. A processing system is configured to pre-populate a cache with at least some of the relevant priming data, load the relevant priming data stored at the cache in response to a trigger event, and execute the application. Upon execution of the application the relevant priming data can be presented at user interface of the user system.

### TECHNICAL FIELD

Embodiments of the subject matter described herein relate generally to priming an application with data. More particularly, embodiments of the subject matter relate to a method and system for intelligent priming of an application with relevant priming data.

### BACKGROUND

Today many enterprises now use cloud-based computing platforms that allow services and data to be accessed over the Internet (or via other networks). Infrastructure providers of these cloud-based computing platforms offer network-based processing systems that often support multiple enterprises (or tenants) using common computer hardware and data storage. This “cloud” computing model allows applications to be provided over a platform “as a service” supplied by the infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Many cloud-based applications are generated based on data that is accessed from storage, and then delivered to a user system such as a mobile device or desktop computer. It is desirable to speed up the process of accessing data that is needed by an application to improve performance and improve user experience with the application.

One way to help speed up access to data is to cache it. Caching can refer to the concept of keeping an updated copy of data (e.g., records) that a user has requested in case the data needs to be used again in the near future. Generally, caching does not involve prediction of which data the user is likely to request, but just which data they have used. When a user stops using an application, data (e.g., a set of items or records) that was most recently accessed/used by the application can be stored in a cache so that it is retained at the user system for future use. This way, the next time the user system loads the application, the data that was most recently accessed/used by the system is available for access without querying remote storage. The data is “cached” so that when the application is executed again, the application can access the data from a cache at the user system so that the application has access to the data that has been most recently accessed by the application. With caching a subsequent user request for data (say record R1) is completed from the cache and is really fast, but the first request that record R1, which fetches record R1 from the network is still slow.

On the other hand, another way to help speed up access to data is to prime it. Priming an application can refer to the process of prefetching data (e.g., records) and storing data (e.g., records) in a cache before they are requested by the user. Priming involves prediction of which records the user is likely to request. With priming, as soon as the application starts up, a system can anticipate a list of data (e.g., records such as R1, R3,R4, R8 and R9) that a user is going to request, and then prefetch them and store them in the cache. This way, if the user attempts to access any of the records that were primed (prefetched) then access is fast.

Currently, a Salesforce server maintains a Most Recently Used (MRU) list of records per user that are used to by the application to prefetch and prime the Salesforce Mobile application. For example, a current version of the Salesforce Mobile platform and applications it provides can use a cache on a mobile device to store the MRU list to improve performance of the application. In one implementation, the application is primed with user's thirty MRU records for each of the user's top seven objects (sometimes also called entities). This MRU list is maintained based on the user's previous browsing history. As a simplified example, if the MRU maintains a list of the five most recently used records (e.g., maximum length of the MRU list is set to five), and a user accesses records L1, L2, L3, L4, R1, R3,R4, R8 and R9 from his desktop, then the last five records (R1, R3,R4, R8 and R9) are retained in the MRU list. If the user opens the Salesforce Mobile application from his mobile phone this list of MRU records (R1, R3,R4, R8 and R9) is prefetched and placed in the cache. In another scenario, if a user accesses the same list say L1, L2, L3, L4, R1, R3,R4, R8 and R9 from his mobile phone, but closes the application after using them, the cache may be cleared (or flushed”) when the application is closed. If he restarts the application this list of MRU records (R1, R3,R4, R8 and R9) is prefetched and placed in the cache. Some or all of the data that is primed in the cache may be consumed by the user. For instance, of the five records prefetched above the user may click on say R3 and R8 only and then click on other records that are not prefetched.

When a user attempts to access a new record that is not in the MRU list, a cache miss occurs, and the application has to make a request to a server system over a network to fetch the relevant record to fulfill the user request. The amount of time needed to fulfill a user's request depends on factors such as the amount of data that needs to be fetched and network bandwidth. As the number of cache misses increases, application performance can suffer, which can lead to a poor user experience. In case of low network bandwidth and/or for records with large amount of data, application performance can especially be bad. When network connectivity is unavailable and/or there is no offline access to the application, it may not even be possible to retrieve a requested record.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an example of a multi-tenant computing environment in which features of the disclosed embodiments can be implemented in accordance with some of the disclosed embodiments.

FIG. 2A is a block diagram that illustrates a system in accordance with the disclosed embodiments.

FIG. 2B is a block diagram that illustrates another system in accordance with the disclosed embodiments.

FIG. 3 is a block diagram that illustrates a system in accordance with the disclosed embodiments.

FIG. 4 is a block diagram that illustrates an intelligent priming module and input parameters received from various input sources in accordance with the disclosed embodiments.

FIG. 5 is a block diagram that illustrates various modules of an intelligent priming module in accordance with the disclosed embodiments.

FIG. 6A is a flowchart that illustrates an exemplary method performed by the intelligent priming module to determine and rank relevant priming data in accordance with the disclosed embodiments.

FIG. 6B is a flowchart that illustrates an exemplary method performed by the intelligent priming module to determine relevant priming data in accordance with one non-limiting example of the disclosed embodiments.

FIG. 6C is a flowchart that illustrates an exemplary method performed to pre-populate a cache with ranked, relevant priming data and then use that ranked, relevant priming data to prime an application provided at a user system in accordance with the disclosed embodiments.

FIG. 7 is a block diagram of one non-limiting example that illustrates how the intelligent priming module can process input parameters from various input sources in accordance with the disclosed embodiments.

FIG. 8 is a block diagram that illustrates an example of an environment in which an on-demand database service can be used in accordance with some implementations.

FIG. 9 is a block diagram that illustrates example implementations of elements of FIG. 8 and example interconnections between these elements according to some implementations.

FIG. 10A is a block diagram that illustrates example architectural components of an on-demand database service environment according to some implementations.

FIG. 10B is a block diagram that further illustrates example architectural components of an on-demand database service environment according to some implementations.

FIG. 11 is a block diagram that illustrates a diagrammatic representation of a machine in the exemplary form of a computer system within which a set of instructions, for causing the machine to perform any one or more of the methodologies discussed herein, may be executed.

### DETAILED DESCRIPTION

Priming a cache based on a static list of MRU records can be inefficient because it may not include records that are requested. This is partly due to the fact that there is no intelligence applied in determining which date (e.g., records) to prime. It would be desirable to provide improved priming technologies that can intelligently predict (e.g., probabilistically) which records are most likely to be of importance, and prime those records instead of simply relying on a static list of MRU records. By applying intelligence when selecting the records that are to be primed, the likelihood of cache misses can be reduced, and application performance can be improved to result in a better user experience.

Methods and systems are provided for intelligent priming. An Intelligent Priming Module (IPM) can process various input parameters to determine relevant priming data for priming an application at a user system. The relevant priming data is predicted to be relevant to a particular user and user system based on one or more of the input parameters. In general, the priming data can include any type of data (e.g., data that is unique to an end user such as records that are associated with the user). A processing system is configured to pre-populate a cache with at least some of the relevant priming data, load the relevant priming data stored at the cache in response to a trigger event, and execute the application. Upon execution of the application the relevant priming data can be presented at user interface of the user system.

The system can include storage that stores data for the application, the IPM configured to determine relevant priming data for priming the application and retrieve the relevant priming data from the storage, the cache that is configured to store relevant priming data, and the processing system that is configured to execute the application and provide the application to the user system. Depending on the implementation, the IPM can be implemented at one or more of the user system and a server system that is configured to communicate with the user system via a network interface. The storage and processing system can be implemented at either the user system or the server system.

The IPM includes an agent module, a trigger module, a prediction engine and a ranking module. The agent module is configured to receive input parameters (described below) associated with the user system and with a particular user of the user system. The trigger module is configured to monitor for occurrence of a priming trigger event. The prediction engine is configured to process the input parameters, in response to the occurrence of the priming trigger event. The predication engine can determine the relevant priming data that is predicted to be relevant to the particular user based on one or more of the input parameters. The ranking module can rank, based on one or more of the input parameters, the relevant priming data according to an order of priority that indicates relative importance to the user. The processing system is configured to pre-populate the cache with at least some of the relevant priming data (ranked according to the order of priority), load the relevant priming data stored at the cache in response to another trigger event, and execute the application. The user system includes a user interface that is configured to present the relevant priming data upon execution of the application.

In one embodiment, to determine the relevant priming data, the prediction engine can determine, based on the input parameters, a current profile that is personalized for the particular user and the user system, and then load a plurality of regression models that are associated with the current profile. The prediction engine can then select, in view of one or more of the input parameters, one of the regression models for the particular user and the user system, and apply the input parameters to the selected regression model to predict the relevant priming data (i.e., data that is predicted to be relevant to the particular user and the user system). The prediction engine can then update, using one or more machine learning processes, the selected regression model based on the current profile and relevant priming data.

The input parameters can include user customer relationship management (CRM) information accessed from a CRM system, constraint information that describes constraints of the user system, intelligence information about the user system, user schedule information associated with the particular user of the user system, habits information that indicate one or more habits of the particular user of the user system, user goal information associated with a goal that the particular user of the user system is working on over a period of time, social media reference information extracted by an agent implemented in conjunction with a social media application, and relevant priming data provided from other complimentary applications associated with the user system (e.g., partner applications that leverage an application platform that provides the application).

The CRM information can include records for any type of object (described below), such as an opportunity object, a lead object, a case object, an account object, reports and dashboards. For example, in one embodiment, the application is served to the user system by a cloud-based application platform, and the priming data includes records each having an object type. For instance, the records can be associated with at least one of: an opportunity object, a lead object, an account object, etc.

The constraint information can include available memory resources of the user system, processing resources of the user system, number of applications currently running at the user system, amount of memory available per application of the user system, and information regarding network connectivity of the user system including currently available bandwidth. The intelligence information can include information about the status of the user system, information about current network connections of the user system, information that describes one or more of: past locations of the user system at certain times, a current location of the user system, or planned future locations of the user system at certain times, etc.

The user schedule information can include any information describing a past schedule event, a present schedule event or future schedule event of the particular user of the user system. The user schedule information can be provided, for example, from one or more calendar applications associated with the particular user of the user system.

Each habit of the user is a regular practice that has a consistent pattern during a specific time frame. The habits information can include one or more of: information obtained from an application that indicates usage of that application by the particular user during the specific time frame; information obtained from a calendar application that indicates an event that the particular user is involved with during the specific time frame; and information obtained from records for objects maintained by the CRM system.

The user goal information describes, for example, a targeted task to be accomplished (e.g., with respect to one or more leads) over the period of time, such as yearly goals or other specific goals as defined by the particular user.

The social media reference information can include information extracted from social media feeds of the social media application or from posts made in the social media application. For example, the social media reference information can include one or more of: a social media handle or other tagging information that identifies the particular user; a topic of a post that includes the particular user; and social media handles or other tagging information from a post by the particular user that identify other people or groups.

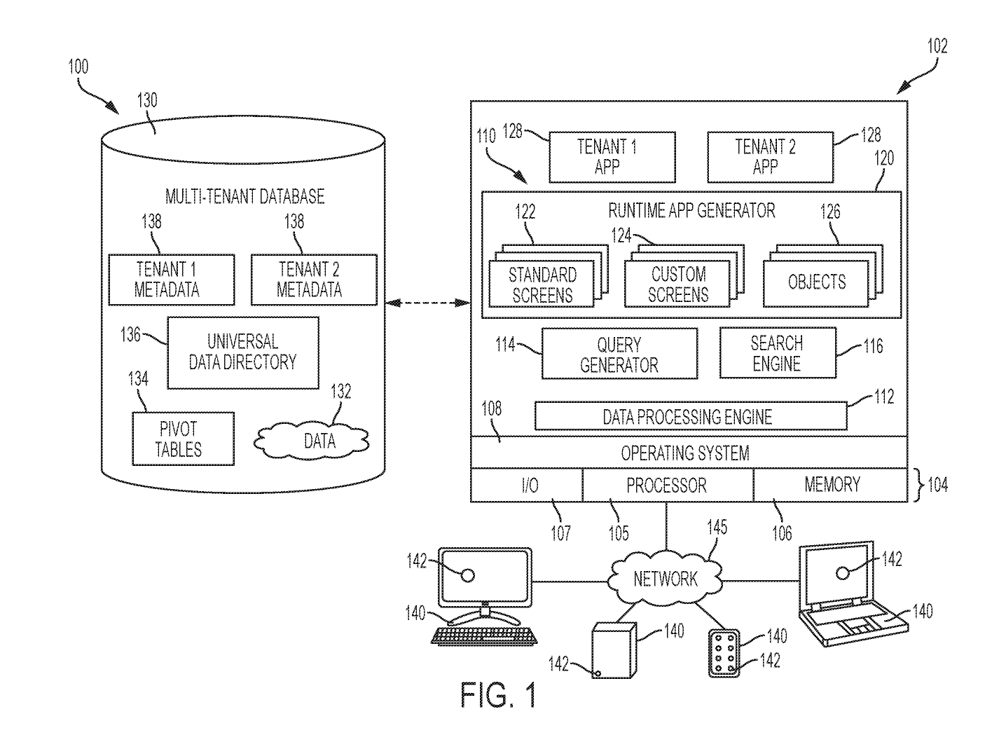

FIG. 1 is a schematic block diagram of an example of a multi-tenant computing environment in which features of the disclosed embodiments can be implemented in accordance with the disclosed embodiments. As shown in FIG. 1, an exemplary cloud-based solution may be implemented in the context of a multi-tenant system 100 including a server 102 that supports applications 128 based upon data 132 from a database 130 that may be shared between multiple tenants, organizations, or enterprises, referred to herein as a multi-tenant database. The multi-tenant system 100 can be shared by many different organizations, and handles the storage of, and access to, different metadata, objects, data and applications across disparate organizations. In one embodiment, the multi-tenant system 100 can be part of a database system, such as a multi-tenant database system.

The multi-tenant system 100 can provide applications and services and store data for any number of organizations. Each organization is a source of metadata and data associated with that metadata that collectively make up an application. In one implementation, the metadata can include customized content of the organization (e.g., customizations done to an instance that define business logic and processes for an organization). Some non-limiting examples of metadata can include, for example, customized content that describes a build and functionality of objects (or tables), tabs, fields (or columns), permissions, classes, pages (e.g., Apex pages), triggers, controllers, sites, communities, workflow rules, automation rules and processes, etc. Data is associated with metadata to create an application. Data can be stored as one or more objects, where each object holds particular records for an organization. As such, data can include records (or user content) that are held by one or more objects.

The multi-tenant system 100 allows users of user systems 140 to establish a communicative connection to the multi-tenant system 100 over a network 145 such as the Internet or any type of network described herein. Based on a user's interaction with a user system 140, the application platform 110 accesses an organization's data (e.g., records held by an object) and metadata that is stored at one or more database systems 130, and provides the user system 140 with access to applications based on that data and metadata. These applications are executed or run in a process space of the application platform 110 will be described in greater detail below. The user system 140 and various other user systems (not illustrated) can interact with the applications provided by the multi-tenant system 100. The multi-tenant system 100 is configured to handle requests for any user associated with any organization that is a tenant of the system. Data and services generated by the various applications 128 are provided via a network 145 to any number of user systems 140, such as desktops, laptops, tablets, smartphones or other client devices, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the system 100. The application platform 110 has access to one or more database systems 130 that store information (e.g., data and metadata) for a number of different organizations including user information, organization information, custom information, etc. The database systems 130 can include a multi-tenant database system 130 as described with reference to FIG. 1, as well as other databases or sources of information that are external to the multi-tenant database system 130 of FIG. 1. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that share access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The server 102, application platform 110 and database systems 130 can be part of one backend system. Although not illustrated, the multi-tenant system 100 can include other backend systems that can include one or more servers that work in conjunction with one or more databases and/or data processing components, and the application platform 110 can access the other backend systems.

The multi-tenant system 100 includes one or more user systems 140 that can access various applications provided by the application platform 110. The application platform 110 is a cloud-based user interface. The application platform 110 can be any sort of software application or other data processing engine that generates the virtual applications 128 that provide data and/or services to the user systems 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the user systems 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user systems 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its user system 140, as appropriate.

The runtime application generator 120 suitably interacts with the query generator 114 to efficiently obtain multi-tenant data 132 from the database 130 as needed in response to input queries initiated or otherwise provided by users of the user systems 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled user system 140 on the network 145. In an exemplary embodiment, the user system 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the user system 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the user system 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

Objects and Records

In one embodiment, the multi-tenant database system 130 can store data in the form of records and customizations. As used herein, the term “record” can refer to a particular occurrence or instance of a data object that is created by a user or administrator of a database service and stored in a database system, for example, about a particular (actual or potential) business relationship or project. The data object can have a data structure defined by the database service (a standard object) or defined by a subscriber (custom object).

An object can refer to a structure used to store data and associated metadata along with a globally unique identifier (called an identity field) that allows for retrieval of the object. In one embodiment implementing a multi-tenant database, all of the records for the tenants have an identifier stored in a common table. Each object comprises a number of fields. A record has data fields that are defined by the structure of the object (e.g. fields of certain data types and purposes). An object is analogous to a database table, fields of an object are analogous to columns of the database table, and a record is analogous to a row in a database table. Data is stored as records of the object, which correspond to rows in a database. The terms “object” and “entity” are used interchangeably herein. Objects not only provide structure for storing data, but can also power the interface elements that allow users to interact with the data, such as tabs, the layout of fields on a page, and lists of related records. Objects can also have built-in support for features such as access management, validation, formulas, triggers, labels, notes and attachments, a track field history feature, security features, etc. Attributes of an object are described with metadata, making it easy to create and modify records either through a visual interface or programmatically.

A record can also have custom fields defined by a user. A field can be another record or include links thereto, thereby providing a parent-child relationship between the records.

Customizations can include custom objects and fields, Apex Code, Visualforce, Workflow, etc.

Examples of objects include standard objects, custom objects, and external objects. A standard object can have a pre-defined data structure that is defined or specified by a database service or cloud computing platform. A standard object can be thought of as a default object. For example, in one embodiment, a standard object includes one or more pre-defined fields that are common for each organization that utilizes the cloud computing platform or database system or service.

A few non-limiting examples of different types of standard objects can include sales objects (e.g., accounts, contacts, opportunities, leads, campaigns, and other related objects); task and event objects (e.g., tasks and events and their related objects); support objects (e.g., cases and solutions and their related objects); salesforce knowledge objects (e.g., view and vote statistics, article versions, and other related objects); document, note, attachment objects and their related objects; user, sharing, and permission objects (e.g., users, profiles, and roles); profile and permission objects (e.g., users, profiles, permission sets, and related permission objects); record type objects (e.g., record types and business processes and their related objects); product and schedule objects (e.g., opportunities, products, and schedules); sharing and team selling objects (e.g., account teams, opportunity teams, and sharing objects); customizable forecasting objects (e.g., includes forecasts and related objects); forecasts objects (e.g., includes objects for collaborative forecasts); territory management (e.g., territories and related objects associated with territory management); process objects (e.g., approval processes and related objects); content objects (e.g., content and libraries and their related objects); chatter feed objects (e.g., objects related to feeds); badge and reward objects; feedback and performance cycle objects, etc. For example, a record can be for a business partner or potential business partner (e.g. a client, vendor, distributor, etc.) of the user, and can include an entire company, subsidiaries, or contacts at the company. As another example, a record can be a project that the user is working on, such as an opportunity (e.g. a possible sale) with an existing partner, or a project that the user is working on.

By contrast, a custom object can have a data structure that is defined, at least in part, by an organization or by a user/subscriber/admin of an organization. For example, a custom object can be an object that is custom defined by a user/subscriber/administrator of an organization, and includes one or more custom fields defined by the user or the particular organization for that custom object. Custom objects are custom database tables that allow an organization to store information unique to their organization. Custom objects can extend the functionality that standard objects provide.

In one embodiment, an object can be a relationship management entity having a record type defined within platform that includes a customer relationship management (CRM) database system for managing a company's relationships and interactions with their customers and potential customers. Examples of CRM entities can include, but are not limited to, an account, a case, an opportunity, a lead, a project, a contact, an order, a pricebook, a product, a solution, a report, a forecast, a user, etc. For instance, an opportunity can correspond to a sales prospect, marketing project, or other business related activity with respect to which a user desires to collaborate with others.

External objects are objects that an organization creates that map to data stored outside the organization. External objects are like custom objects, but external object record data is stored outside the organization. For example, data that's stored on premises in an enterprise resource planning (ERP) system can be accessed as external objects in real time via web service callouts, instead of copying the data into the organization.

Intelligent Priming

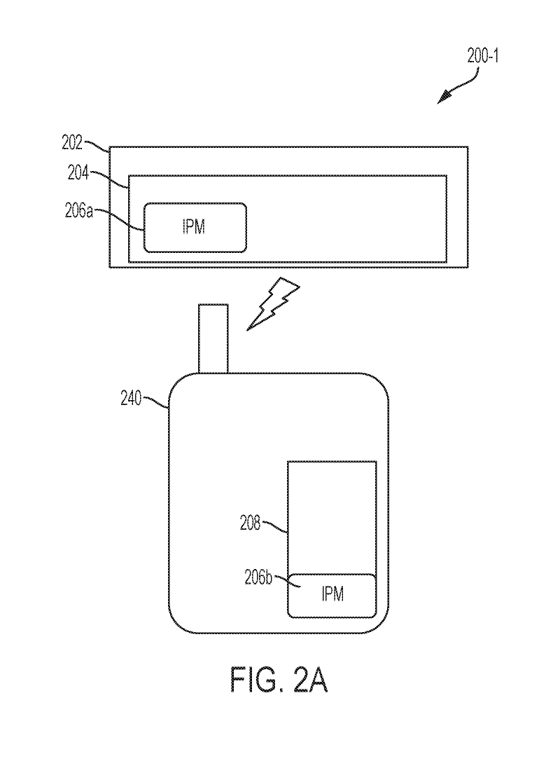

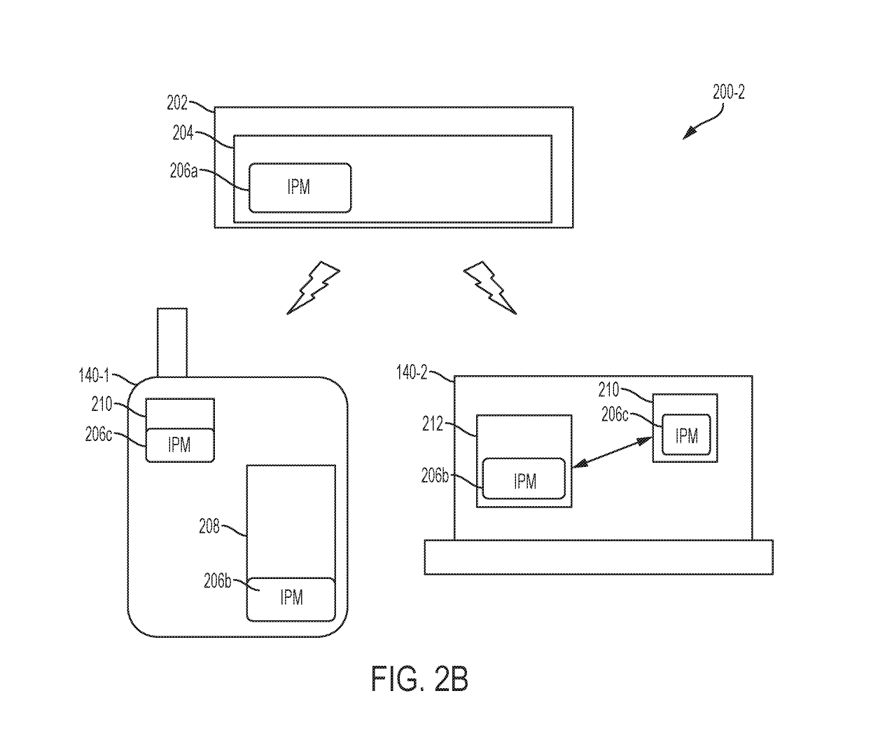

FIG. 2A illustrates a system 200-1 in accordance with the disclosed embodiments. In this embodiment, the system 200-1 includes a server system 202 that communicates with a user system 140-1. The server system 202 includes an application 204, or application platform 204 that serves applications to user systems. The user system 140-1 can also include an application 208.

An intelligent priming module (IPM) 206 can be implemented, for example, to provide relevant priming data in conjunction with any type of cloud-based application or cloud-based application platform, any web application, or any client-server application. The application can access data (e.g., records) from an address space of a process that is different than the address space of the process that executes the application. In general, the application can be hosted at the same system as the server system or at a different system than the server system. Depending on the implementation, data can be stored at storage that can be, for example, remote storage (e.g., cloud-based storage) or local storage (e.g., a database of a server system). In the context of applications provided by Salesforce.com, the IPM 206 can also be implemented to provide relevant priming data for applications provided by cloud-based application platforms, such as, the Salesforce mobile application, Lightning applications (SFX), or any variants thereof. For example, in one embodiment, the application 204 can be a mobile application 204 served by an application platform 204, such as Salesforce mobile application that is built using the Aura or Lightning platform. The Lightning Component framework is a UI framework for developing dynamic web apps for mobile and desktop devices. The framework supports partitioned multi-tier component development that bridges the client and server. It uses JavaScript on the client side and Apex on the server side. The Lightning App Builder empowers users to build apps visually, without code, using off-the-shelf and custom-built Lightning components to build custom user interfaces without code. Using these technologies, new standalone Lightning applications can be customized and easily deployed and used by mobile devices running the Salesforce mobile app.

In accordance with the embodiment illustrated in FIG. 2A, the IPM 206 can be implemented using IPMs 206a, 206b that are implemented as client-server system at both the server system 202 and the user system 140-1. However, it should be appreciated that in alternative embodiments, the IPM 206 can be implemented only at the user system 140-1 (e.g., as a client-only system), or implemented only at the server system 202 (e.g., as a server-only system). Furthermore, although FIG. 2A illustrates only a single user system 140-1, it should be appreciated that any number of user systems can be used in conjunction with the server system 202.

As will be described in greater detail below, the IPM 206 primes the application 208 with priming data (e.g., records) that are relevant to the user of the user system 140-1. The IPM 206 can process various input parameters (e.g., information that describes constraints and persona information associated with the user) to determine which priming data (e.g., records) are relevant to the user of the user system 140-1. As will be described in greater detail below, the input parameters can take into account intelligence information that reflects characteristics associated with the user of the user system 140-1 and characteristics of the particular user system 140-1 being used by the user to determine which data is relevant priming data. In one embodiment, where the IPM 206 is implemented in conjunction with a mobile client application 208 or application platform 208, such as Salesforce Mobile, the IPM 206 primes records for different object/entity types of the Salesforce Mobile application as at least some of the relevant priming data.

FIG. 2B illustrates another system 200-2 in accordance with the disclosed embodiments. The system 200-2 includes a server system 202 that communicates with user systems 140-1, 140-2. The server system 202 includes a server application 204, and the user systems 140-1, 140-2 each include an application 208, 212.

As with FIG. 2A, the user system 140-1 is implemented as a mobile client, and the IPM 206b at user system 140-1 primes the application 208 with relevant priming data. Other details regarding the application 208 and IPM 206b of the user system 140-1 are described above with reference to FIG. 2A and will not be described again for sake of brevity. In some implementations, the application 208 (e.g., Salesforce cloud application) can also provide relevant priming data for the complimentary applications 210 (e.g., partner applications or complimentary Salesforce applications like a Field Service application). For instance, in one implementation, where the application 208 is a mobile client application 208, such as the Salesforce Mobile application, the IPM 206b can determine relevant priming data provided from other the complimentary applications 210 (e.g., complimentary Salesforce applications like the Salesforce Field Service application). For instance, the IPM 206 can provide priming data for a Field Service application provided by Salesforce so that relevant priming data (e.g., records) can be primed for field service personnel. However, in other implementations, as illustrated in FIG. 2B, each complimentary application 210 can have its own dedicated IPM 206c.

In addition, in this embodiment, another user system 140-2 can be implemented as a non-mobile client that includes a client application 212 and/or browser application 212. In one embodiment, the client application 212 can run within the browser application 212. Another IPM 206b can be implemented in conjunction with the client application 212 or browser application 212. The IPM 206b for user system 140-2 can provide relevant priming data (e.g., records for the objects of Salesforce cloud application) for the client application 212 or browser application 212 for user systems (e.g., desktop, laptop or tablet devices, etc.). In some implementations, the IPM 206b that is implemented in conjunction with the client application 212 or browser application 212 (e.g., Salesforce cloud application) can also prime data for complimentary applications 210 at the user system 140-2 (e.g., complimentary Salesforce applications like a Field Service application). In some implementations, as illustrated in FIG. 2B, each complimentary application 210 can have its own IPM 206c.

In one embodiment, each of the IPMs 206b sends information or input parameters (e.g., updates about location of the user system, applications that are in use, device constraints, status and actions) to the IPM 206a at the server application 204, which uses this information, along with other information (e.g., other information from other applications that are used at the user system), to determine relevant priming data for the application(s) 208, 212 implemented at the user systems 140-1, 140-2 as well as how detailed the relevant priming data should be. For example, if the user is going to be in an office location, a greater number of records can be primed versus a situation where that user is going to board the plane, in which case a fewer number of records can be primed, but with more details for each of the records being primed. For instance, when the user places the user system in “airplane mode” this could also be an example of a forced priming trigger event that can trigger priming of multiple layers of the records that are associated with each other so that the user has access not only to a main record being primed as an instance of relevant priming data, but also all other related records that are linked to the main record as other instances of relevant priming data. As another example, if a record type has multiple different layouts, the IPM 206 may intelligently decide which layouts to prime (e.g., IPM 206 can prime read only layouts when network bandwidth is low and resume priming edit layouts once the device has higher bandwidth available).

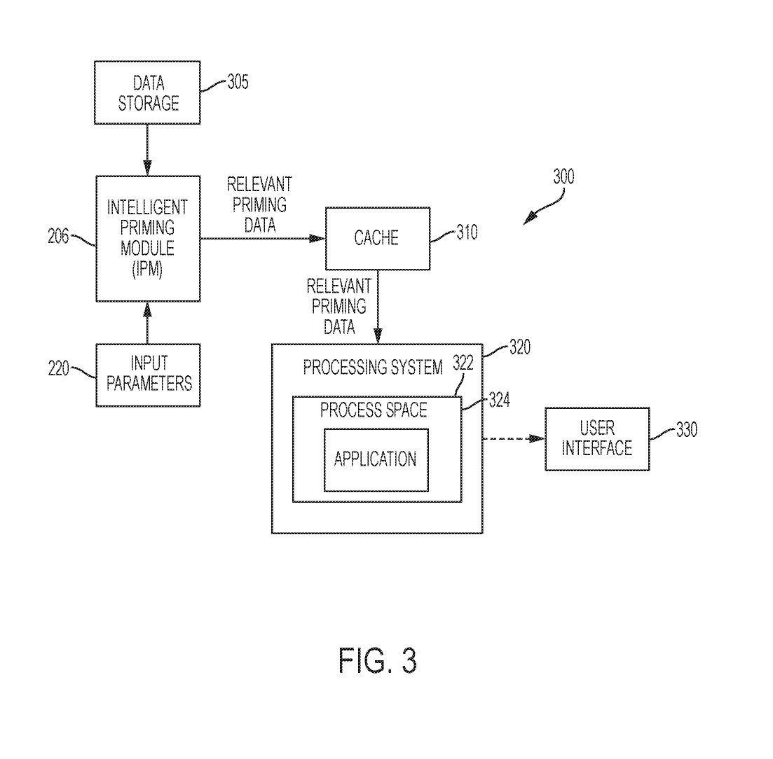

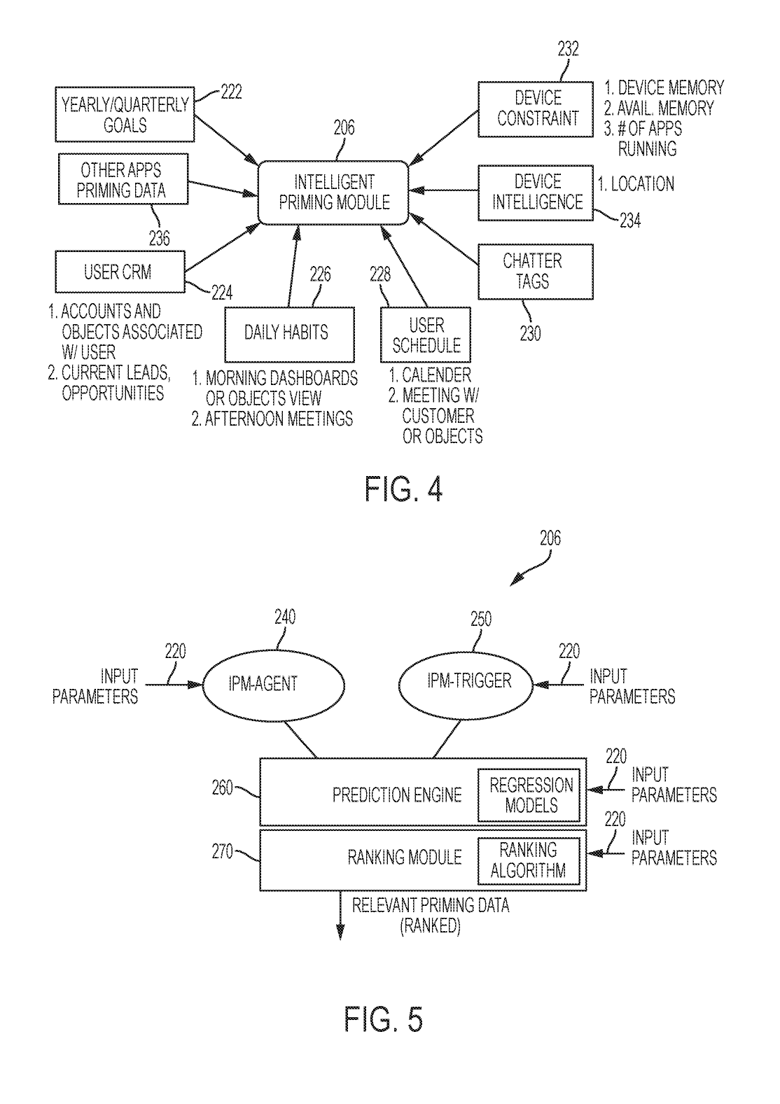

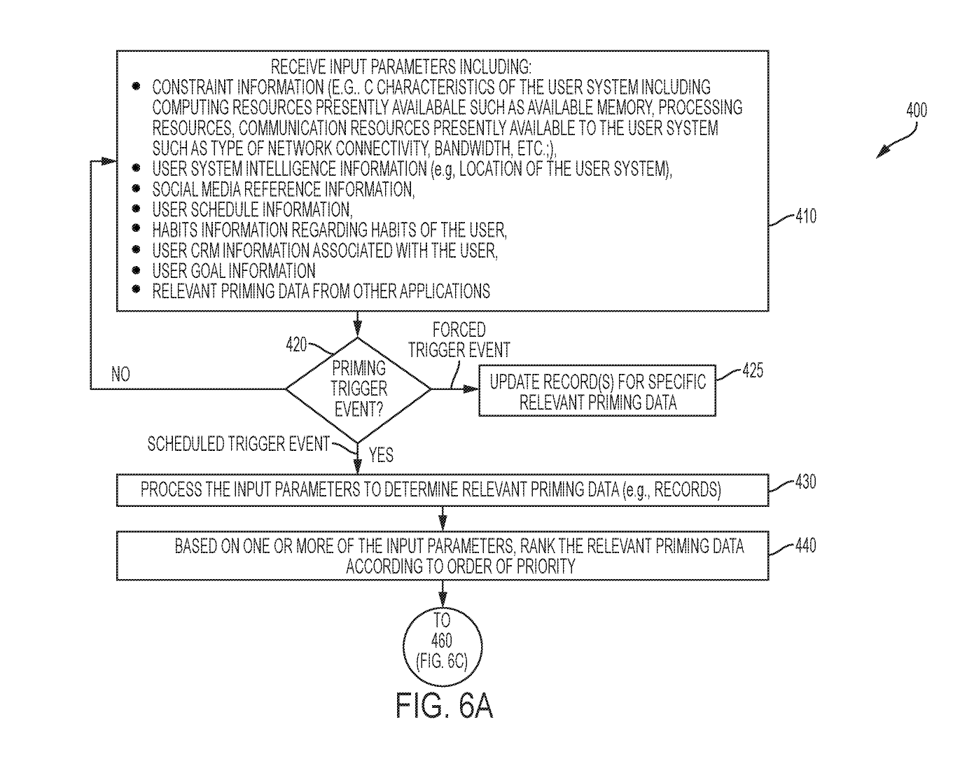

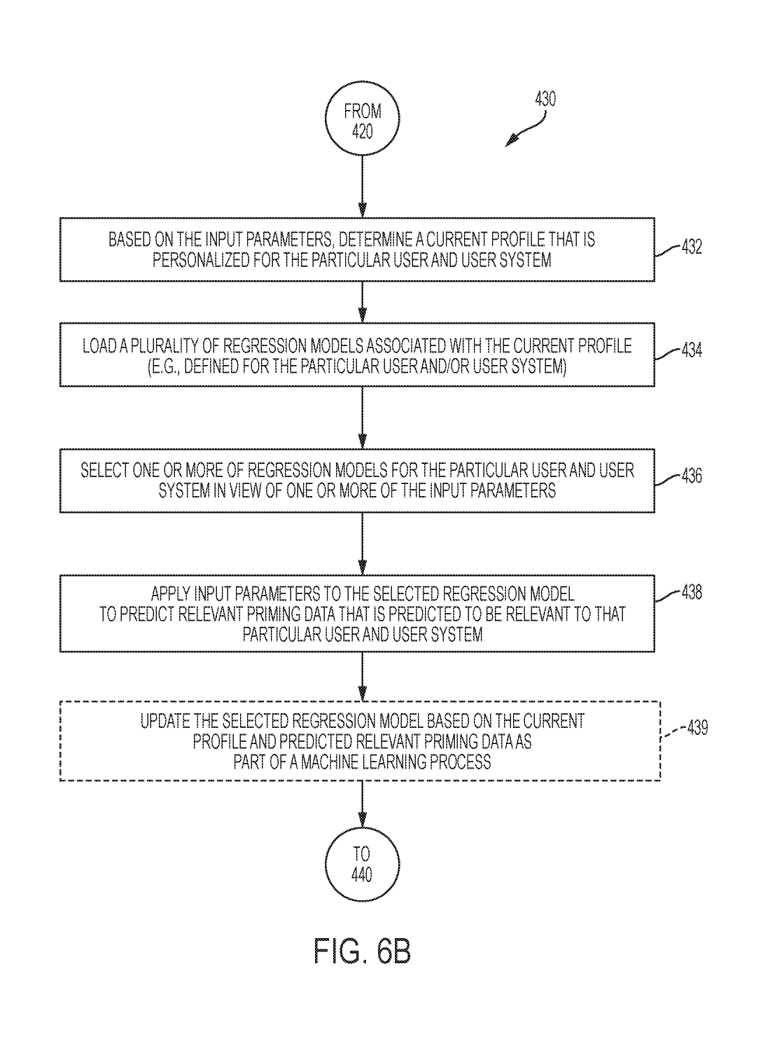

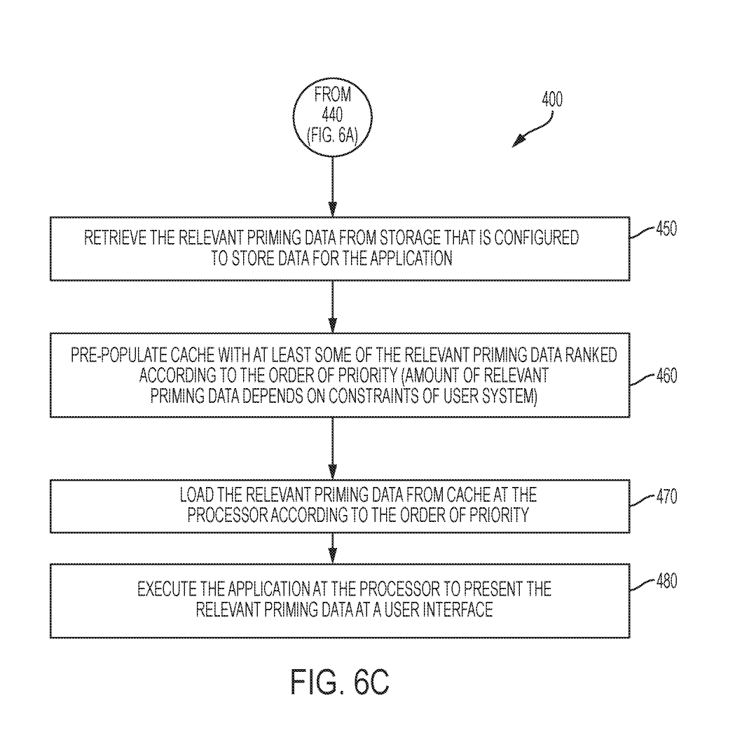

FIG. 3 is a block diagram that illustrates a system 300 in accordance with the disclosed embodiments. FIG. 4 illustrates an IPM 206 and input parameters 220 received from various input sources 222-234 in accordance with the disclosed embodiments. FIG. 5 illustrates various modules 240, 250, 260, 270 of an IPM 206 in accordance with the disclosed embodiments. FIG. 6A through 6C are a series of flowcharts that collectively illustrate a method performed in accordance with the disclosed embodiments. FIGS. 3 through 6B will be described together with reference to one another and with continued reference to FIGS. 2A and 2B.

With respect to FIGS. 6A-6C, the steps of each method shown are not necessarily limiting. Steps can be added, omitted, and/or performed simultaneously without departing from the scope of the appended claims. Each method may include any number of additional or alternative tasks, and the tasks shown need not be performed in the illustrated order. Each method may be incorporated into a more comprehensive procedure or process having additional functionality not described in detail herein. Moreover, one or more of the tasks shown could potentially be omitted from an embodiment of each method as long as the intended overall functionality remains intact. Further, each method is computer-implemented in that various tasks or steps that are performed in connection with each method may be performed by software, hardware, firmware, or any combination thereof. For illustrative purposes, the following description of each method may refer to elements mentioned above in connection with FIGS. 1-5. In certain embodiments, some or all steps of these methods, and/or substantially equivalent steps, are performed by execution of processor-readable instructions stored or included on a processor-readable medium. For instance, in the description of FIGS. 6A-6C that follows, the IPM 206 (and its agent module 240, trigger module 250, prediction engine 260 and ranking module 270) the processing system 320, and the user interface 330, can be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together. Furthermore, in the description of FIGS. 6A-6C, a particular example is described in which a user system performs certain actions by interacting with other elements of the systems described herein.

As shown in FIG. 3, the system 300 includes data storage 305 for storing data for an application 324, an IPM 206, a cache 310, a processing system 320 having a process space 322 that is used to execute the application 324, and a user interface 330. The storage 305, the IPM 206, the cache 320, the processing system 320 can be implemented at a user system and/or at a server system that is configured to communicate with the user system via a network interface. The user interface 330 is implemented at a user system.

The IPM 206 can be implemented at one or more of the user system and a server system. The IPM 206 receives input parameters 220 from various input sources (not shown in FIG. 3) that can be either part of the system 300 or external to the system 300. As will be described below, the input parameters 220 can be intelligently processed by the prediction engine 260 of the IPM 206 (e.g. in response to the occurrence of the priming trigger event) to determine/predict relevant priming data for priming the application. The relevant priming data is particular data from storage that is determined to be relevant to a particular user of a user system, such as user system 140-1, 140-2. The IPM 206 can retrieve the relevant priming data from storage 305, and send it to the cache 310 where it can be stored until needed to prime the application 324.

In one embodiment, to determine the relevant priming data, the prediction engine 260 can determine, based on the input parameters, a current profile that is personalized for the particular user and the user system, and then load a plurality of regression models (RMs) that are associated with the current profile. The prediction engine can then select, in view of one or more of the input parameters, one of the regression models for the particular user and the user system, and apply the input parameters to the selected regression model to predict the relevant priming data (i.e., data that is predicted to be relevant to the particular user and the user system). The prediction engine can then update, using one or more machine learning processes, the selected regression model based on the current profile and relevant priming data.

The ranking module 270 can apply one or more ranking algorithms to rank, based on one or more of the input parameters, the relevant priming data according to an order of priority that indicates relative importance to the user.

The processing system 320 is configured to load the relevant priming data stored at the cache (e.g., in response to a trigger event), and execute the application. When the processing system 320 executes the application 324 in the process space 322, the processing system 320 can load at least some of the relevant priming data from the cache 310 so that it can be used at the application 324. The user system includes a user interface 330 that is configured to present the relevant priming data upon execution of the application. Upon execution of the application 324, the application 324 can be output with the relevant priming data presented/rendered/displayed via the user interface 330.

As shown in FIG. 4, the IPM 206 includes various input sources 222-234 that provide input parameters or other information to the IPM 206. As will be describe below, the input parameters can be intelligently processed by the IPM 206 to determine/predict relevant priming data that is relevant to a particular user of a user system, such as user system 140-1, 140-2. In this embodiment, non-limiting examples of input sources 222-234 can include: user goal information 222, user CRM information 224 for a user, habits information 226, user schedule information 228, social media reference information 230, user system intelligence information 232, user system constraint information 234, and other relevant priming data 236 provided from other applications.

The user goal information 222 includes any information that is associated with a goal or target that a user is working on. The user goal information 222 can include things such as goals of a user, group or organization over a time period such as daily, monthly, quarterly or yearly goals, etc. As one non-limiting example, the user goal information can describe a targeted task to be accomplished (e.g., with respect to one or more leads) over the period of time. For instance, each goal or target can be associated with one or more leads that the user is currently working on, has worked on, or will be working on in the future. An example of a goal or target can be a certain task, such as sales, to a client or other contact during a specific period of time. The user goal information 222 may be obtained from a CRM system and can be a specific type of CRM record as will now be described below.

The user CRM information 224 for the user can include any information that a user has access to from a CRM system. The user CRM information 224 for the user can include information from records for any type of object including accounts, current leads, current opportunities, and any other objects (described above) that are associated with the user of the user system, and that the user has access to. In the event, a user is currently working with, or attempting to access, a record for a particular type of object, this can serve as a trigger event that will cause the prediction engine to request and determine relevant priming data (e.g., records) for other related types of objects. In other words, when a user accesses a record, the prediction engine to request and determine associated records that are relevant or related to the record currently being accessed.

For instance, when a user accesses a record for an opportunity object, the prediction engine can request and determine associated records for such as an associated account record, leads records, company details like current news feeds, and any other records that are relevant or related to the record for the opportunity object that is currently being accessed. These records can then be ranked by a ranking module/algorithm, and at least some of these records can be loaded into a cache as part of the relevant priming data.

The habits information 226 can include information that indicates habits of the user over a time frame (e.g., hourly habits, daily habits), where a habit is a regular tendency or practice that has an identifiable and consistent pattern during a time frame. The time frame can be a time or time-range and/or date or date-range. The habits information 226 can include information that is provided or extracted from calendar applications, any type of objects, a dashboards view, a meetings view, etc. that indicates the user's habits over a certain time frame. In one embodiment, habits information 226 can include information that reflects daily or hourly usage patterns of the user. The habits information 226 can be obtained, for example, from an application that indicates usage of that application by the particular user during the specific time frame. As another example, the habits information 226 can be obtained, for example, from a calendar application that indicates an event that the particular user is involved with during the specific time frame. As yet another example, the habits information 226 can be obtained, for example, from records for objects maintained by the CRM system For instance, habits information 226 can include information that indicates that the user tends to use a certain application or use/view a certain object during a given time period (e.g., spends the majority of their time in an account object every Wednesday from 9 AM to 11 AM), and that the user tends to have a conference call the first work day of every month from 1:00 PM to 2:30 PM. The habits information 226 can be used to schedule a trigger, and to restrict the scope of relevant priming data so that it is more tailored to the user's habits during certain time periods.

The user schedule information 228 can include any information about any information describing a past schedule event, a present schedule event or future schedule event of the particular user of the user system 240. The user schedule information 228 can be extracted, for example, from one or more calendar applications associated with the user. In general terms, a calendar application is software that provides users with an electronic version of a calendar that displays dates and times, and a host of other features including appointment calendaring, scheduling and reminders, availability sharing, integrated email, calendar publishing, an address book and/or contact list (e.g., a list of contacts with information to enable users to communicate with the contacts), time management software, etc. Some examples of calendar applications can include iCal™, Mozilla™ Sunbird, Windows™ Live Calendar, Google™ Calendar, Microsoft™ Office 365, Microsoft™ Outlook with Exchange Server, Salesforce.com Calendar. Each of these applications present an interface that allows a user to create an event at a specified time. The user may track various events, including meetings that the user has been invited to. Most calendar applications also allow a user to send invite requests for events to other users. When an invitee receives the request, the invitee can choose to accept or decline the request. If the invitee accepts, a corresponding event is typically created in the invitee's calendar.

In some embodiments, a calendar application can include contextual information displayed on or in conjunction with the calendar, where the contextual information indicates context for the calendar, and can include calendar data and/or third-party data linked to calendar items that are displayed in the calendar.

In this regard, calendar data can include, for example, data defined on the calendar (e.g., data backing the calendar that is used to properly display the calendar, retrieve the items to display on the calendar and/or to generally interact with the calendar). Calendar data can also include data defined on items that are displayed in the calendar, where items can include one or more calendar events and/or calendarable records being displayed on the calendar. Data defined on the items that are displayed in the calendar can include events or records that are linked to a calendar. Events or records can be any piece of data that contain the minimum requirements to be displayed on a calendar. In one embodiment, a calendar object can hold calendar records of an organization. The minimum requirements are at least one date/time datum of the data in a format allowing to be used to position the data on the calendar relative to the time displayed on the calendar. The event may contain more data not specifically required by the minimum requirements for being displayed on a calendar. Some non-limiting examples of calenderable records can include things such as events, opportunities, tasks, contacts, cases, accounts, leads, etc. For instance, an opportunity can correspond to a sales prospect, marketing project, or other business-related activity with respect to which a user desires to collaborate with others. Third-party data can include data linked to calendar items that are associated with and/or displayed in the calendar. Third-party data can include any information collected or stored about an event or a record by an entity that does not have a direct relationship with the event/record the data is being collected on.

It should also be noted that a user may have more than one calendar application. For example, a given user might have a work calendar, different group calendars within their work calendar, a personal calendar, children's calendar, etc. For example, a group calendar can be used to display calendar events for certain groups that a user is involved in at work. A user can combine and merge different calendars together to gain a better picture of all events on all calendars.

The user schedule information 228 can include things such as: calendar information including calendar event information such as customer meetings, appointments, or calls, and any other information that is displayed in a calendar application, etc. This information can be used for many different purposes by the IPM 206 including, for example, in conjunction with other information to generate relevant priming data.

The social media reference information 230 can include any information provided by or extracted from social media feeds or posts in a social media application. The social media reference information 230 can include things such as social media handles or tagging information that identifies the user or mentions the user in a post, a topic of a post, or invitations to an event or events posted on social media that are relevant to the user (e.g., an event that is about to start in the next few hours). For example, an agent can be implemented in conjunction with the social media application. The agent can keep track of recent posts made by the user and/or recent posts that the user is tagged in. The agent can then compile a list of other people (i.e., people other than the user) who are tagged in the user's posts or who made posts that the user is tagged in, and this list can then be used to retrieve relevant priming data (e.g., records) that are associated with the other people who are included in that list. For instance, in the context of the Chatter social media application, Chatter @mentions or other associated mentions can be tracked. In addition, or alternatively, the agent can compile a list of post topics by the user and/or that the user is tagged in, and this list can then be used to retrieve relevant priming data (e.g., records) that are associated with the post topics that are included in that list. The relevant priming data can then be ranked by the ranking module and the cache can be populated with any of the records that are ranked high enough to meet the ranking criteria.

The user system intelligence information 232 can include any intelligence that is provided by or that can be obtained from other sources about the user system. Examples of user system intelligence information 232 can include things such as the status of the user system, information about current network connections of the user system, the past locations of the user system at certain times, current location of the user system, or planned future locations of the user system at certain times as determined, for example, from user schedule information 228 or other information. The user system intelligence information 232 can be obtained for each user system associated with a user.

The user system constraint information 234 provides information regarding constraints of the user system. Different user systems (e.g., devices) different hardware and software resources. The user system constraint information 234 can include things such as: information that describes system or device constraints such as total memory resources, available memory resources, processing resources, number of applications currently running, amount of memory available per application, network connectivity, available bandwidth or data rates, etc.

Other relevant priming data 236 that is provided from other applications, such as complimentary applications or partner applications that leverage the same application platform, can be another input parameter. For example, when the IPM 206 is determining relevant priming data for an application delivered by the Salesforce Mobile application platform, other relevant priming data 236 can be provided from Salesforce complimentary applications and/or Salesforce Partner Applications which leverage the Salesforce Mobile platform. In one embodiment, the other relevant priming data 236 can be fed into the ranking module directly and ranked by the ranking module. The cache can be populated with any of the other relevant priming data 236 that are ranked high enough to meet the ranking criteria.

As shown in FIG. 5, in one embodiment, the IPM 206 includes an agent module 240, a trigger module 250, a prediction engine 260, and a ranking module 270. FIG. 6A is a flowchart that illustrates a method 400 performed by the IPM 206 to determine and rank relevant priming data in accordance with the disclosed embodiments, and will be described with reference to FIG. 5.

At 410, the agent module 240 receives input parameters and configurations. Additionally, the agent module 240 receives a scheduled or forced priming trigger event to execute logic that controls or runs the IPM 206. The input parameters (described above) are associated with the user system and with a particular user of the user system.

At 420, the trigger module 250 can monitor for and detect the occurrence of a priming trigger event, and then generate a notification that is provided to the prediction engine. For example, in one embodiment, the trigger module 250 can process, analyze, or evaluate one or more of the input parameters to monitor for trigger events and generate appropriate notification messages that can be used to trigger the prediction engine 260 to determine relevant priming information (e.g., records of the user). Trigger events can be scheduled or forced. The trigger module 250 can continuously monitor for the occurrence of a scheduled priming trigger event, or the occurrence of a forced priming trigger event.

Scheduled trigger events can be scheduled on a regular basis (e.g., hourly, daily, weekly, etc.) to trigger the process of updating the relevant priming data. For instance, the habits information 226 can be used to schedule a scheduled trigger event because the user's behavior is predictable during certain time periods during which the user has identifiable habits.

By contrast, forced trigger events can occur when certain criteria are satisfied to trigger the process of updating the relevant priming data, such as when the user system is at a particular location, or when certain access conditions are met, or when other conditions occur such as when the user is mentioned in a social media feed (e.g., when certain @mentions occur in the context of Chatter).

As one possible example, the trigger module 250 can use the location of the user system (e.g., obtained from user system intelligence information 232) to create a scheduled priming trigger event, or a forced priming trigger event. For instance, when the trigger module 250 determines that the user system is at an airport and knowing the time of the flight from user schedule information 228 (e.g., obtained from a calendar event in a calendar application), the trigger module 250 can determine that a forced priming trigger event has occurred, and generate a notification message that is sent to the prediction engine to force the prediction engine to prime the relevant priming data so that the user will have access to certain data as the user boards his or her flight. For instance, the prediction engine 260 can determine the relevant priming data includes various forms of data for the future customer offsite meetings, and then take actions to prime that relevant priming data for the user system.

As another possible example, when the trigger module 250 determines that the user has accessed an email record (e.g., accesses an email record on Salesforce Email client (Salesforce Inbox), the trigger module 250 can determine that a forced priming trigger event has occurred, and generate a notification message that is sent to the prediction engine. The notification message can force the prediction engine to prime the relevant priming data based on information that is part of the email record (e.g., a recipient the email record is addressed to) so that the user will have access to other records that are predicted to be relevant. For instance, the prediction engine can determine the records that are relevant to the recipient (e.g., relevant records related to the recipient based on an @mention), and then take actions to prime that relevant priming data for the user system.

When a forced priming trigger event occurs (at 420), the trigger module 250 can generate a notification message that is sent to the prediction module 260 to trigger updates for specific instances of relevant priming data (e.g., to trigger updates for specific records of the existing relevant priming data). For instance, if there is a social meeting or Chatter based @mention, a specific record of the existing relevant priming data can be automatically updated so that when the user tries to open the specific record in an application that specific record will already be available in the cache.

When a scheduled priming trigger event occurs (at 420), the trigger module 250 can generate a notification message that is sent to the prediction module 260 to trigger updates to the priming data. At 430, in response to the occurrence of the scheduled priming trigger event and receipt of a notification message from the trigger module 250, the prediction module 260 can process the input parameters to determine relevant priming data. The relevant priming data is data that is predicted to be relevant to the particular user based on one or more of the input parameters.

Some or all of the input parameters described above may be processed at 430 to determine which data qualifies as relevant priming data (or potentially relevant priming data) depending on the implementation. In general, the input parameters that are processed at 430 can vary depending on characteristics of the particular user and the particular user system. For example, when the particular user belongs to a certain group or team, such as a sales team, the priming data that is relevant can differ significantly from the priming data that is relevant for another member of the sales team who has a different role. The priming data that is relevant can also vary depending on the time of day (e.g., start of the day versus end of the day), or day of the week (e.g., start of the work week versus end of the work week; weekday versus weekend, etc.), or other time factors (e.g., the end of a sales quarter versus the beginning). The habits information 226 can be used to restrict the scope of relevant priming data so that it is more tailored to the user's habits during certain time periods. In addition, the priming data that is deemed to be relevant, and/or the amount of relevant priming data that is cached, can vary depending on constraints 232 of the user system and available connectivity (e.g., bandwidth currently available to send the relevant priming data or latency).

One non-limiting embodiment of step 430 will now be described with reference to FIG. 6B. FIG. 6B is a flowchart that illustrates a method 430 performed by the IPM 206 to determine relevant priming data in accordance with one non-limiting example of the disclosed embodiments.

At 432, the prediction engine 260 can determine, based on one or more of the input parameters (or information that is part of any input parameter), a current profile that is personalized for the particular user and user system. A profile for a user and user system can vary. A user can have different profiles that vary depending on the role of the user, the particular organization that the user is associated with or belongs to, the particular input parameters, etc. For example, single user can have a profile for each organization the user visits. For instance, a user logging into an engineering organization (e.g., Org62) will have a different profile than when that same user logs on to a company-wide organization (e.g., GUS). A profile can define, for example, objects that are typically used by that particular user within the context a particular organization. A profile can have, for example, list of people, groups or topics a user is following, the users age, interests, etc.

The input parameters that are processed at 432 to determine the current profile can vary depending on characteristics of the particular user and the particular user system. For example, user CRM information 224 or user goal information 222 for a user can be used to determine that the particular user belongs to a certain group or team, such as a sales team. The profile (or profiles) that are potentially applicable to that user can differ significantly from other profiles that are relevant other users who belong to other different groups or teams or who have different roles. The profile(s) that are applicable for a particular user can also vary based on other factors. For example, the profiles available for a user can vary depending on whether the user is planning to travel or stay in the same general location (as determined, for example, by user schedule information 228 and/or user system intelligence information 232). As another example, profile(s) that are applicable for a particular user can also vary based on location of the user system (as determined from user system intelligence information 232), or mobility of the user system (as determined from user system constraint information 234).

At 434, the prediction engine 260 can then load a plurality of regression models that are associated with the current profile that was determined at 432. Non-limiting examples of regression models can include, for example, “no network calls during user access of records,” “once a day synchronization,” “no limit network requests during user interaction,” “no network calls for user perceived page load,” and any other known regression models.

At 436, the prediction engine 260 can then select one or more of the regression models for the particular user and user system in view of one or more of the input parameters, information that is part of any input parameter, interests of the user or other information. Here again, the input parameters that are processed at 434 can vary depending on characteristics of the particular user and the particular user system.

For example, user CRM information 224 or user goal information 222 for a user can be used to determine that the particular user belongs to a certain group or team, such as a sales team. The regression model that should be selected for that user and user system can differ significantly from other regression models that are relevant other users who belong to other different groups or teams or who have different roles. The regression model that should be selected for a particular user can also vary based on other factors. For example, the regression model that should be selected for a particular user can vary depending on whether the user is planning to travel or stay in the same general location (as determined, for example, by user schedule information 228 and/or user system intelligence information 232). As another example, regression model that should be selected for a particular user can also vary based on location of the user system (as determined from user system intelligence information 232), or mobility of the user system (as determined from user system constraint information 234). The regression model that should be selected can also vary depending on the time of day (e.g., start of the day versus end of the day), or day of the week (e.g., start of the work week versus end of the work week; weekday versus weekend, etc.), or other time factors (e.g., the end of a sales quarter versus the beginning). In addition, the regression model that should be selected, can vary depending on constraints of the user system (e.g., available connectivity or bandwidth currently available).

At 438, the prediction engine 260 can then apply the input parameters to the selected regression model to predict the relevant priming data (i.e., data, such as records, that are predicted to be relevant to the particular user and the user system). The input parameters that are evaluated/processed/analyzed by the regression model at step 438 can vary depending on the regression model that was selected (at 436). A given regression model processes particular ones of the input parameters and outputs priming data that is relevant (i.e., relevant priming data) based on characteristics of the particular user and the particular user system.

During each iteration of the process of generating relevant priming data, the IPM 206 is configured to continuously learn (via machine learning processes or algorithms) how to improve each of the regression modules. To facilitate this, as part of a machine learning process at 439, the prediction engine 260 can update the selected regression model based on the current profile and the predicted relevant priming data. For example, a machine learning process can process this information to identify characteristics or patterns that are shared with other information that is part of the regression model, and then modify the regression model (and/or other regression models) appropriately so that they are optimized for a given user profile.

After 438 is complete, the ranking module 270 can then rank, at 440, the relevant priming data in a priority order according to its relative importance. In one embodiment, the ranking module 270 outputs a matrix that includes one or more instances of relevant priming data (e.g., one or more records) ordered according to relative priority. The relevant priming data can also include other information, such as, a start date/time that indicates when each instance of relevant priming data (e.g., each record) should be loaded, and a data time life that indicates how long each instance of relevant priming data (e.g., each record) should remain as part of the relevant priming data.

In one embodiment, the algorithm used by the ranking module 270 is configurable based on preferences of the end user. For example, in one implementation, a weighting value is assigned to each input parameter that indicates its relative importance, and the user can set/adjust weighting values associated with various input parameters to scale the relative importance of that input parameter. For example, a user can weigh his daily habits more than his calendar schedule. In that case, ranking algorithm can increase the number of records related to his/her daily habits more than his/her calendar. By default, if the user does not change weighting values associated with various input parameters, the ranking module 270 will use default weighting values to rank the relevant priming data. In addition, it should be noted that the user can also set/adjust weighting values associated with various types of relevant priming data so that each type of relevant priming data can be assigned an adjustable weight value that indicates its relative importance. This allows the user to tune the ranking algorithm(s) to suit their individual preferences.

In one embodiment, the ranking module 270 can rank the relevant priming data according to order of priority based on one or more of the input parameters, information that is part of any input parameter, or other information. The input parameters that are used at step 439 to rank the relevant priming data can vary depending on characteristics of the particular user and the particular user system.

FIG. 6C is a flowchart that illustrates a method performed to pre-populate a cache 310 with ranked, relevant priming data and then use that ranked, relevant priming data to prime an application provided at a user system in accordance with the disclosed embodiments, and will be described with continued reference to FIG. 5.

After ranking the relevant priming data (at 440), at 450, the IPM 206 can retrieve the relevant priming data from storage 305 that is configured to store data for the application. Depending on the implementation, the storage 305 can be implemented at either the user system or the server system.

The IPM 206 can then provide the ranked, relevant priming data to the processing system 320, and at 460, the processing system 320 can then pre-populate the cache 310 with at least some of the relevant priming data. The amount of the relevant priming data that can be primed depends on characteristics of the user system. The amount of relevant priming data that is selected and used to pre-populate the cache 310 can depend on various factors including, for example, the time of the day, and the capabilities and constraints of user system such as the memory capacity of the cache, the number of applications, the amount of available memory, the amount of memory that can be allocated per application for priming data, network connectivity (e.g., bandwidth and latency currently available to send the relevant priming data), etc. The amount relevant priming data that is sent to the cache 310, or transferred from the cache 310 to the application, can be determined based on any number or combination of these factors, or other input parameters. For instance, the relevant priming data may be too large for a certain type of device, or the available bandwidth can be too low to transfer a large number of records, and therefore the amount of relevant priming data that is transferred can be determined based on these factors.

At 470, the processing system 320 can load, in response to another trigger event, the relevant priming data stored at the cache 310. This other trigger event can vary depending on the implementation. For example, this other trigger event could be a change in state, such as the application being opened, executed or loaded; occurrence of a condition or a predetermined event such as the location of the user changing, the current or future occurrence of a calendar event, or connectivity being unavailable, etc.

At 480, the application can be executed to present the relevant priming data via a user interface 330 (e.g., as the GUI of the application). Depending on the implementation, the application can be executed locally at the processing system 320 of the user system or at an application platform and delivered to the user system.

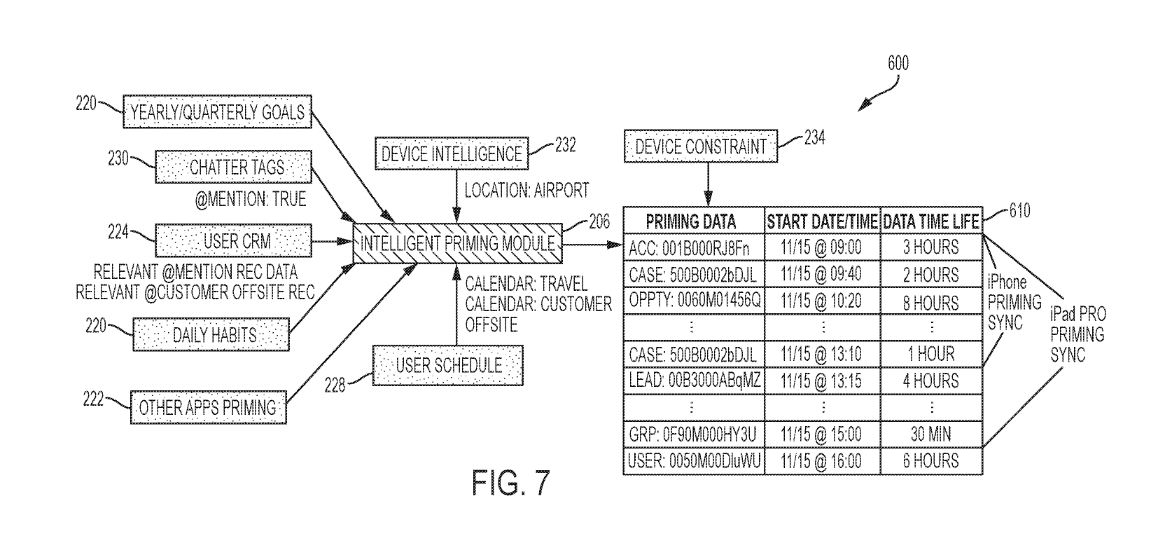

FIG. 7 is a block diagram of one non-limiting example that illustrates how the IPM 206 can process input parameters from various input sources 222-234 in accordance with one example implementation of the disclosed embodiments, where the user of the user system has arrived at an airport in preparation for a flight. Depending on the implementation and conditions involved in a particular scenario, information from some or all of the input sources 222-234 can be used/processed by the IPM 206 to determine/predict the relevant priming data that is relevant to a particular user of a user system. One non-limiting scenario will be described where input parameters from certain input sources can be processed to determine/predict the relevant priming data (shown as 610).

In this non-limiting example, the IPM 206 processes information from input parameters including user goal information 222, user CRM information 224 for a user, habits information 226, user schedule information 228, social media reference information 230, user system intelligence information 232, user system constraint information 234, and other relevant priming data 236 provided from other applications. Depending on the implementation various data (e.g., records) for each type of input parameter could be relevant priming data. In this simplified example, the user CRM information 224 for the user includes relevant @mention rec data, relevant @mention customer offsite rec, and the social media reference information 230 includes @mention: true. For example, if user 2 wants user 1 to respond to a particular post user 2 can @mention user 1 in a message by using user 1's login name: “@user 1 can you please look into this issue and let me know what you find.” Using @user 1 sends user 1 pointed emails and reminders. If a user's name was @ mentioned in a social media post, email or elsewhere, then that user will likely want to read that post soon and hence may want that post and other relevant data and records that are determined to be relevant to be loaded into their mobile phone. A user can also @mention groups, or any other objects as well.

In this example, the trigger module 250 (FIG. 5) of the IPM 206 uses user system intelligence information 232 that indicates that the device is located at an airport, and user schedule information 228 (e.g., from a calendar application) to determine that the user has a calendar event that indicates that the user will be traveling, and has an upcoming meeting (Customer offsite). The trigger module can use the location of the user system (e.g., obtained from user system intelligence information 232) to create a scheduled priming trigger event, or a forced priming trigger event. For instance, when the trigger module 250 determines that the user system is at an airport (e.g., obtained from a calendar event in a calendar application which can be a type of user system intelligence information 232) and knowing the time of the flight from user schedule information 228 (e.g., obtained from another calendar event in a calendar application which can be a type of user system intelligence information 232), the trigger module 250 can determine that a forced priming trigger event has occurred, and generate a notification message that is sent to the prediction engine to trigger priming of records that make up the relevant priming data. At the same time, other priming trigger event(s) may be scheduled on a regular basis and also trigger the prediction engine to prime relevant priming data.

The prediction engine 260 (FIG. 5) of the IPM 206 can then process various other input parameters and determine which data qualifies as relevant priming data. For example, in one embodiment, the prediction engine 260 can determine, based on one or more of the input parameters (or information that is part of any input parameter), a current profile that is personalized for the particular user and user system, and can then load a plurality of regression models that are associated with the current profile. One (or more) of the regression models for the current profile (that are defined by the particular user and user system) can then be selected. The selection can be based on user input, or can be automated in view of one or more of the input parameters, information that is part of any input parameter, or other information. Here again, the input parameters that are processed can vary depending on characteristics of the particular user and the particular user system. The prediction engine 260 can then apply the input parameters to the selected regression model(s) to predict the relevant priming data (i.e., data, such as records, that are predicted to be relevant to the particular user and the user system). The input parameters that are evaluated/processed/analyzed by the regression model(s) can vary depending on the regression model(s) that was/were selected. A given regression model processes particular ones of the input parameters and outputs priming data that is relevant (i.e., relevant priming data) based on characteristics of the particular user and the particular user system.

In this specific, non-limiting example, the prediction engine 260 can determine the relevant priming data 610 includes various forms of data for the future customer offsite meetings, and then take action to prime that data for the user system. For example, the prediction engine 260 can use information about travel plans (e.g., from the user schedule information 228) to determine the amount of time the user may be disconnected or in offline state while in flight, and then use information about future calendar meetings (e.g., from the user schedule information 228) and the location of the user system (e.g., obtained from user system intelligence information 232) to determine the relevant priming data (e.g., data that is predicted to be important for those calendar meetings that will occur after the user arrives at their destination).

The ranking module 270 (FIG. 5) of the IPM 206 can then dynamically rank all of the instances of relevant priming data according to relative priority and determine which instances should be loaded to pre-populate the cache. For example, the IPM 206 can also process user system constraint information 234 that indicates the type of device (e.g., iPhone 6S or iPad PRO), and other information about the device, such as, available memory resources, number of applications currently running, amount of memory available per application, and network connectivity. From this, the ranking module 270 of the IPM 206 can determine the amount of relevant priming data that can be primed at the cache and loaded at the application of the user system prior to the scheduled departure of the flight. This way priming data that is likely to be most relevant to the user, based on the current profile for that user and user system, will be available to the user.

In this non-limiting example, the relevant priming data 610 is illustrated at a particular instant in time. The relevant priming data is updated continuously as input parameters change. To illustrate one simplified example, it will be assumed, for sake of simplicity, that the IPM 206 has determined that for this specific user system (not shown) a number of instances of relevant priming data 610 are relevant priming data. It should be appreciated that the example illustrated in FIG. 7 is simplified for purposes of illustration and that examples could be more complex in many scenarios. It should be appreciated that fewer or many more instances could be loaded depending on the implementation.

In this example, the first column of table shows the relevant priming data that can be loaded into the cache as the relevant priming data. Although only seven instances of relevant priming data 610 are shown, it should be appreciated that the blank rows in the table can each represent any number of other instance of relevant priming data that are not shown, and that any additional number of rows can be included each of which can include another instance of relevant priming data 610. In this example, the instances of priming data that are determined to be most relevant are shown in column 1 in order of priority. In this example, the relevant priming data can include the following records:

a record for an account object (ACC: 001B000RJ8Fn) that is an instance of priming data associated with the user CRM information 224 type of input parameter, and has an identifier 001B000RJ8Fn,

a record for a case object (CASE: 500B0002bDJL) that is an instance of priming data associated with the user CRM information 224 type of input parameter, and has an identifier 500B0002bDJL,

a record for an opportunity object (OPPTY: 0060M01456Q) that is an instance of priming data associated with the user CRM information 224 type of input parameter, and has an identifier 0060M01456Q,

a record for a case object (CASE: 500B0002bDJL) that is an instance of priming data associated with the user CRM information 224 type of input parameter, and has an identifier 500B0002bDJL,

a record for a lead object (LEAD: 00B3000ABqMZ) that is an instance of priming data associated with the user CRM information 224 type of input parameter, and has an identifier 00B3000ABqMZ,

a record associated with a group (GRP: 0F90M000HY3U) that is an instance of priming data associated with the user CRM information 224 type of input parameter, and has an identifier 0F90M000HY3U, and

a record associated with a user (USER: 0050M00DIuWU) that is an instance of priming data associated with the user CRM information 224 type of input parameter, and has an identifier 0050M00DIuWU.

In column 1, each instance of the relevant priming data (e.g., one or more records) are ordered according to relative priority as ranked by the ranking module. For example, of the records shown in column 1, the record for the account object (ACC: 001B000RJ8Fn) has the highest priority, and the record associated with the user (USER: 0050M00DIuWU) has the lowest priority.

Each instance of relevant priming data can also include other information that is associated with it. For example, in one embodiment, as shown in FIG. 7, each instance of relevant priming data can also include a start date/time (shown in column 2) that indicates when each instance of relevant priming data (e.g., each record) should be loaded, and a data time life (shown in column 3) that indicates how long each instance of relevant priming data (e.g., each record) should remain as part of the relevant priming data.

Some of all of the instances of the relevant priming data can be loaded depending, for example, on the user system intelligence information 232 and/or user system constraint information 234. For example, as shown in FIG. 7, for an iPhone, a number of instances of relevant priming data may be loaded that include, but are not limited to, the records for the account object (ACC: 001B000RJ8Fn), the case object (CASE: 500B0002bDJL), the opportunity object (OPPTY: 0060M01456Q), any other intervening records that are not illustrated, and the case object (CASE: 500B0002bDJL). These would be the top ranked instances of data that were determined to have the highest priority. By contrast, for an iPad PRO, which has more available memory that the iPhone, a larger number of instances of relevant priming data may be loaded that include, but are not limited to, the records for the account object (ACC: 001B000RJ8Fn), the case object (CASE: 500B0002bDJL), the opportunity object (OPPTY: 0060M01456Q), any other intervening records that are not illustrated, the case object (CASE: 500B0002bDJL), the lead object (LEAD: 00B3000ABqMZ), any other intervening records that are not illustrated, and the group (GRP: 0F90M000HY3U). Again, these would be the top ranked instances of data that were determined to have the highest priority.

The following description is of one example of a system in which the features described above may be implemented. The components of the system described below are merely one example and should not be construed as limiting. The features described above with respect to FIGS. 1-7 may be implemented in any other type of computing environment, such as one with multiple servers, one with a single server, a multi-tenant server environment, a single-tenant server environment, or some combination of the above.

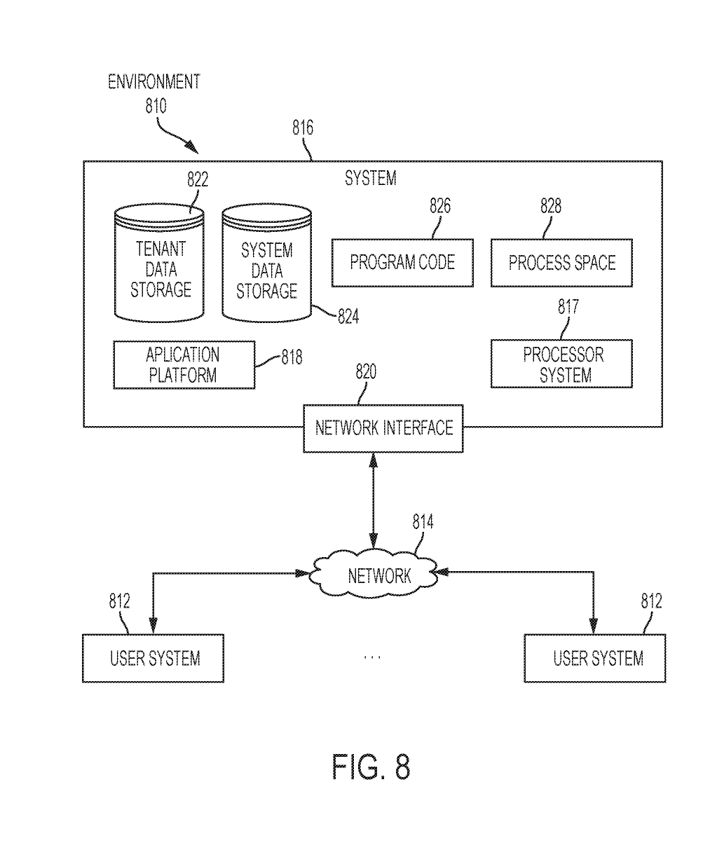

FIG. 8 shows a block diagram of an example of an environment 810 in which an on-demand database service can be used in accordance with some implementations. The environment 810 includes user systems 812, a network 814, a database system 816 (also referred to herein as a “cloud-based system”), a processor system 817, an application platform 818, a network interface 820, tenant database 822 for storing tenant data 823, system database 824 for storing system data 825, program code 826 for implementing various functions of the system 816, and process space 828 for executing database system processes and tenant-specific processes, such as running applications as part of an application hosting service. In some other implementations, environment 810 may not have all of these components or systems, or may have other components or systems instead of, or in addition to, those listed above.

In some implementations, the environment 810 is an environment in which an on-demand database service exists. An on-demand database service, such as that which can be implemented using the system 816, is a service that is made available to users outside of the enterprise(s) that own, maintain or provide access to the system 816. As described above, such users generally do not need to be concerned with building or maintaining the system 816. Instead, resources provided by the system 816 may be available for such users' use when the users need services provided by the system 816; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 818 can be a framework that allows the applications of system 816 to execute, such as the hardware or software infrastructure of the system 816. In some implementations, the application platform 818 enables the creation, management and execution of one or more applications developed by the provider of the on-demand database service, users accessing the on-demand database service via user systems 812, or third party application developers accessing the on-demand database service via user systems 812.

In some implementations, the system 816 implements a web-based customer relationship management (CRM) system. For example, in some such implementations, the system 816 includes application servers configured to implement and execute CRM software applications as well as provide related data, code, forms, renderable web pages and documents and other information to and from user systems 812 and to store to, and retrieve from, a database system related data, objects, and Web page content. In some MTS implementations, data for multiple tenants may be stored in the same physical database object in tenant database 822. In some such implementations, tenant data is arranged in the storage medium(s) of tenant database 822 so that data of one tenant is kept logically separate from that of other tenants so that one tenant does not have access to another tenant's data, unless such data is expressly shared. The system 816 also implements applications other than, or in addition to, a CRM application. For example, the system 816 can provide tenant access to multiple hosted (standard and custom) applications, including a CRM application. User (or third party developer) applications, which may or may not include CRM, may be supported by the application platform 818. The application platform 818 manages the creation and storage of the applications into one or more database objects and the execution of the applications in one or more virtual machines in the process space of the system 816.

According to some implementations, each system 816 is configured to provide web pages, forms, applications, data and media content to user (client) systems 812 to support the access by user systems 812 as tenants of system 816. As such, system 816 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 814 can be or include any network or combination of networks of systems or devices that communicate with one another. For example, the network 814 can be or include any one or any combination of a LAN (local area network), WAN (wide area network), telephone network, wireless network, cellular network, point-to-point network, star network, token ring network, hub network, or other appropriate configuration. The network 814 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 812 can communicate with system 816 using TCP/IP and, at a higher network level, other common Internet protocols to communicate, such as HTTP, FTP, AFS, WAP, etc. In an example where HTTP is used, each user system 812 can include an HTTP client commonly referred to as a “web browser” or simply a “browser” for sending and receiving HTTP signals to and from an HTTP server of the system 816. Such an HTTP server can be implemented as the sole network interface 820 between the system 816 and the network 814, but other techniques can be used in addition to or instead of these techniques. In some implementations, the network interface 820 between the system 816 and the network 814 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 812 can be implemented as any computing device(s) or other data processing apparatus or systems usable by users to access the database system 816. For example, any of user systems 812 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 812 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 816) of the user system 812 to access, process and view information, pages and applications available to it from the system 816 over the network 814.

Each user system 812 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 812 in conjunction with pages, forms, applications and other information provided by the system 816 or other systems or servers. For example, the user interface device can be used to access data and applications hosted by system 816, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 812 may differ in their respective capacities, and the capacity of a particular user system 812 can be entirely determined by permissions (permission levels) for the current user of such user system. For example, where a salesperson is using a particular user system 812 to interact with the system 816, that user system can have the capacities allotted to the salesperson. However, while an administrator is using that user system 812 to interact with the system 816, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 812 and some or all of its components are operator-configurable using applications, such as a browser, including computer code executed using a central processing unit (CPU) such as an Intel Pentium® processor or the like. Similarly, the system 816 (and additional instances of an MTS, where more than one is present) and all of its components can be operator-configurable using application(s) including computer code to run using the processor system 817, which may be implemented to include a CPU, which may include an Intel Pentium® processor or the like, or multiple CPUs.

The system 816 includes tangible computer-readable media having non-transitory instructions stored thereon/in that are executable by or used to program a server or other computing system (or collection of such servers or computing systems) to perform some of the implementation of processes described herein. For example, computer program code 826 can implement instructions for operating and configuring the system 816 to intercommunicate and to process web pages, applications and other data and media content as described herein. In some implementations, the computer code 826 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

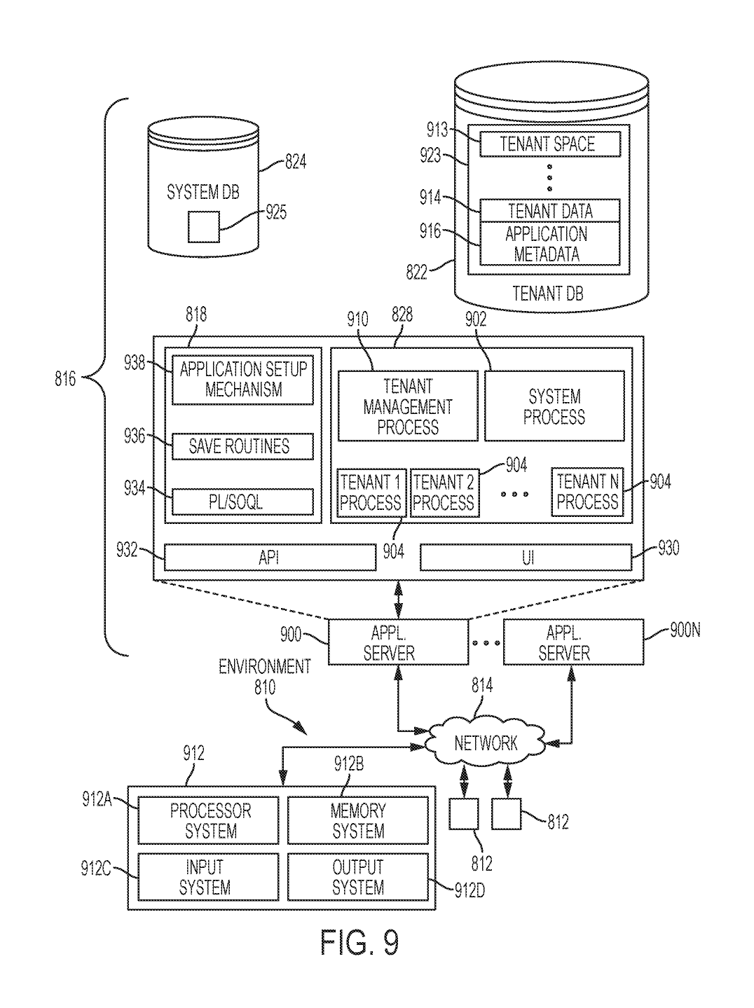

FIG. 9 shows a block diagram of example implementations of elements of FIG. 8 and example interconnections between these elements according to some implementations. That is, FIG. 9 also illustrates environment 810, but FIG. 9, various elements of the system 816 and various interconnections between such elements are shown with more specificity according to some more specific implementations. Elements from FIG. 8 that are also shown in FIG. 9 will use the same reference numbers in FIG. 9 as were used in FIG. 8. Additionally, in FIG. 9, the user system 812 includes a processor system 912A, a memory system 912B, an input system 912C, and an output system 912D. The processor system 912A can include any suitable combination of one or more processors. The memory system 912B can include any suitable combination of one or more memory devices. The input system 912C can include any suitable combination of input devices, such as one or more touchscreen interfaces, keyboards, mice, trackballs, scanners, cameras, or interfaces to networks. The output system 912D can include any suitable combination of output devices, such as one or more display devices, printers, or interfaces to networks.

In FIG. 9, the network interface 820 of FIG. 8 is implemented as a set of HTTP application servers 900₁-1400_{N}. Each application server 900, also referred to herein as an “app server,” is configured to communicate with tenant database 822 and the tenant data 923 therein, as well as system database 824 and the system data 925 therein, to serve requests received from the user systems 912. The tenant data 923 can be divided into individual tenant storage spaces 913, which can be physically or logically arranged or divided. Within each tenant storage space 913, tenant data 914 and application metadata 916 can similarly be allocated for each user. For example, a copy of a user's most recently used (MRU) items can be stored to user storage 914. Similarly, a copy of MRU items for an entire organization that is a tenant can be stored to tenant storage space 913.

The process space 828 includes system process space 902, individual tenant process spaces 904 and a tenant management process space 910. The application platform 818 includes an application setup mechanism 938 that supports application developers' creation and management of applications. Such applications and others can be saved as metadata into tenant database 822 by save routines 936 for execution by subscribers as one or more tenant process spaces 904 managed by tenant management process 910, for example. Invocations to such applications can be coded using PL/SOQL 934, which provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 816 for the subscriber making the invocation and executing the metadata as an application in a virtual machine.

The system 816 of FIG. 9 also includes a user interface (UI) 930 and an application programming interface (API) 932 to system 816 resident processes to users or developers at user systems 912. In some other implementations, the environment 810 may not have the same elements as those listed above or may have other elements instead of, or in addition to, those listed above.

Each application server 900 can be communicably coupled with tenant database 822 and system database 824, for example, having access to tenant data 923 and system data 925, respectively, via a different network connection. For example, one application server 900₁ can be coupled via the network 814 (for example, the Internet), another application server 900_{N} can be coupled via a direct network link, and another application server (not illustrated) can be coupled by yet a different network connection. Transfer Control Protocol and Internet Protocol (TCP/IP) are examples of typical protocols that can be used for communicating between application servers 900 and the system 816. However, it will be apparent to one skilled in the art that other transport protocols can be used to optimize the system 816 depending on the network interconnections used.

In some implementations, each application server 900 is configured to handle requests for any user associated with any organization that is a tenant of the system 816. Because it can be desirable to be able to add and remove application servers 900 from the server pool at any time and for various reasons, in some implementations there is no server affinity for a user or organization to a specific application server 900. In some such implementations, an interface system implementing a load balancing function (for example, an F5 Big-IP load balancer) is communicably coupled between the application servers 900 and the user systems 912 to distribute requests to the application servers 900. In one implementation, the load balancer uses a least-connections algorithm to route user requests to the application servers 900. Other examples of load balancing algorithms, such as round robin and observed-response-time, also can be used. For example, in some instances, three consecutive requests from the same user could hit three different application servers 900, and three requests from different users could hit the same application server 900. In this manner, by way of example, system 816 can be a multi-tenant system in which system 816 handles storage of, and access to, different objects, data and applications across disparate users and organizations.

In one example storage use case, one tenant can be a company that employs a sales force where each salesperson uses system 816 to manage aspects of their sales. A user can maintain contact data, leads data, customer follow-up data, performance data, goals and progress data, etc., all applicable to that user's personal sales process (for example, in tenant database 822). In an example of a MTS arrangement, because all of the data and the applications to access, view, modify, report, transmit, calculate, etc., can be maintained and accessed by a user system 912 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 816 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 816 also can maintain system level data usable by multiple tenants or other data. Such system level data can include industry reports, news, postings, and the like that are sharable among tenants.

In some implementations, the user systems 912 (which also can be client systems) communicate with the application servers 900 to request and update system-level and tenant-level data from the system 816. Such requests and updates can involve sending one or more queries to tenant database 822 or system database 824. The system 816 (for example, an application server 900 in the system 816) can automatically generate one or more SQL statements (for example, one or more SQL queries) designed to access the desired information. System database 824 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

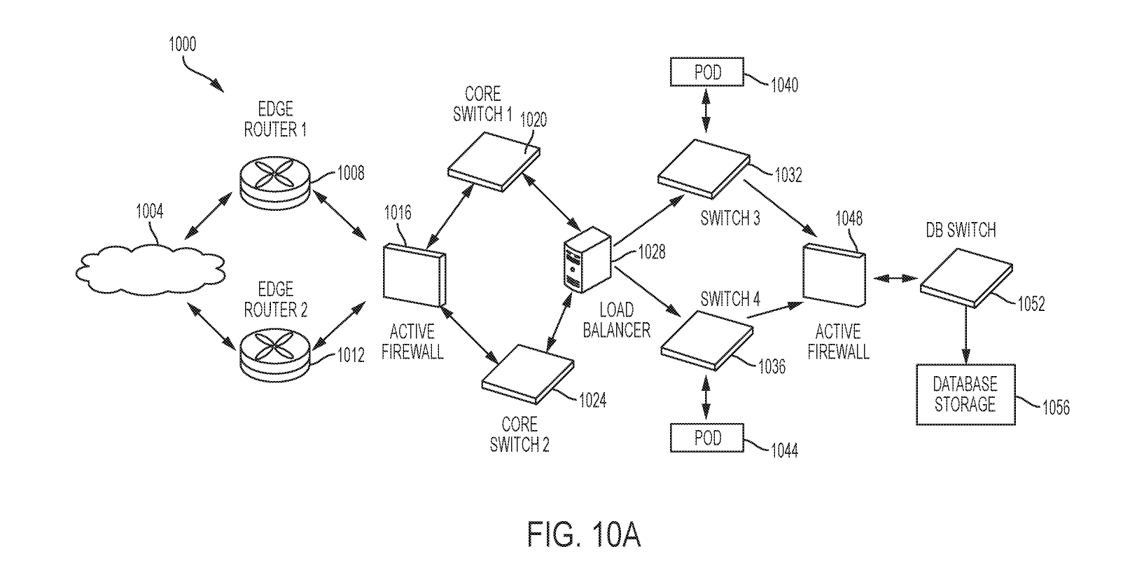

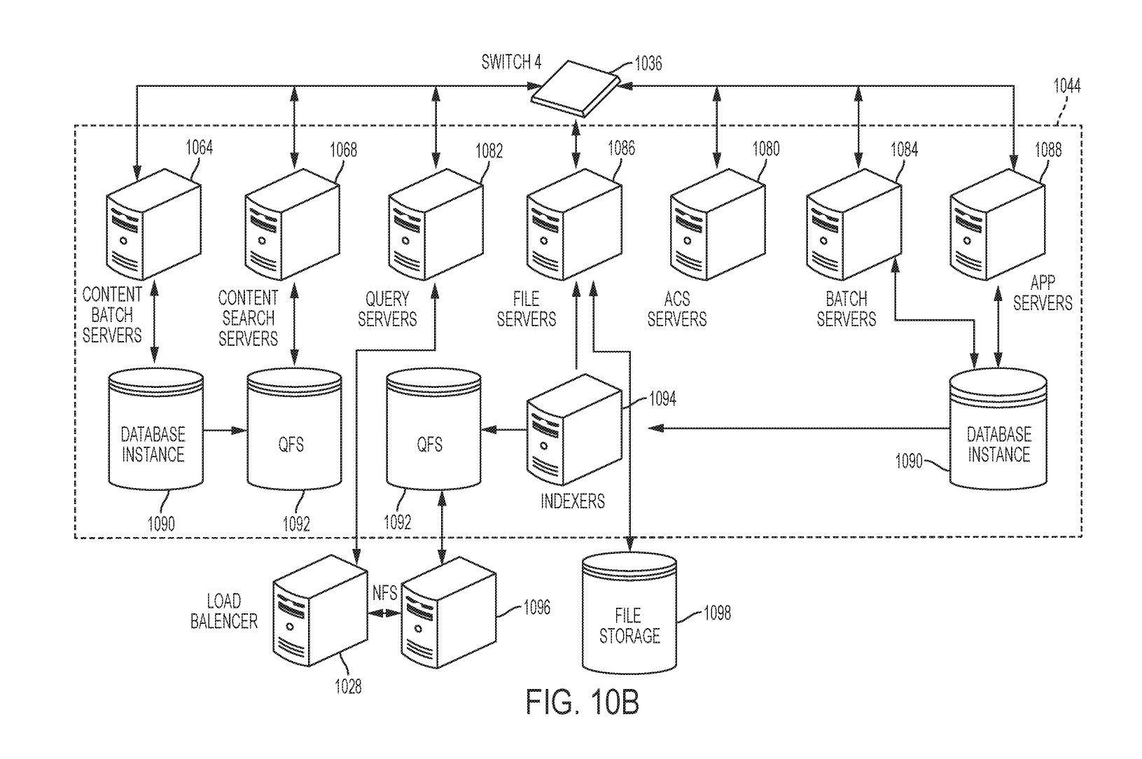

FIG. 10A shows a system diagram illustrating example architectural components of an on-demand database service environment 1000 according to some implementations. A client machine communicably connected with the cloud 1004, generally referring to one or more networks in combination, as described herein, can communicate with the on-demand database service environment 1000 via one or more edge routers 1008 and 1012. A client machine can be any of the examples of user systems 12 described above. The edge routers can communicate with one or more core switches 1020 and 1024 through a firewall 1016. The core switches can communicate with a load balancer 1028, which can distribute server load over different pods, such as the pods 1040 and 1044. The pods 1040 and 1044, which can each include one or more servers or other computing resources, can perform data processing and other operations used to provide on-demand services. Communication with the pods can be conducted via pod switches 1032 and 1036. Components of the on-demand database service environment can communicate with database storage 1056 through a database firewall 1048 and a database switch 1052.

As shown in FIGS. 10A and 10B, accessing an on-demand database service environment can involve communications transmitted among a variety of different hardware or software components. Further, the on-demand database service environment 1000 is a simplified representation of an actual on-demand database service environment. For example, while only one or two devices of each type are shown in FIGS. 10A and 10B, some implementations of an on-demand database service environment can include anywhere from one to several devices of each type. Also, the on-demand database service environment need not include each device shown in FIGS. 10A and 10B, or can include additional devices not shown in FIGS. 10A and 10B.

Additionally, it should be appreciated that one or more of the devices in the on-demand database service environment 1000 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 1004 is intended to refer to a data network or multiple data networks, often including the Internet. Client machines communicably connected with the cloud 1004 can communicate with other components of the on-demand database service environment 1000 to access services provided by the on-demand database service environment. For example, client machines can access the on-demand database service environment to retrieve, store, edit, or process information. In some implementations, the edge routers 1008 and 1012 route packets between the cloud 1004 and other components of the on-demand database service environment 1000. For example, the edge routers 1008 and 1012 can employ the Border Gateway Protocol (BGP). The BGP is the core routing protocol of the Internet. The edge routers 1008 and 1012 can maintain a table of IP networks or ‘prefixes’, which designate network reachability among autonomous systems on the Internet.

In some implementations, the firewall 1016 can protect the inner components of the on-demand database service environment 1000 from Internet traffic. The firewall 1016 can block, permit, or deny access to the inner components of the on-demand database service environment 1000 based upon a set of rules and other criteria. The firewall 1016 can act as one or more of a packet filter, an application gateway, a stateful filter, a proxy server, or any other type of firewall.

In some implementations, the core switches 1020 and 1024 are high-capacity switches that transfer packets within the on-demand database service environment 1000. The core switches 1020 and 1024 can be configured as network bridges that quickly route data between different components within the on-demand database service environment. In some implementations, the use of two or more core switches 1020 and 1024 can provide redundancy or reduced latency.

In some implementations, the pods 1040 and 1044 perform the core data processing and service functions provided by the on-demand database service environment. Each pod can include various types of hardware or software computing resources. An example of the pod architecture is discussed in greater detail with reference to FIG. 10B. In some implementations, communication between the pods 1040 and 1044 is conducted via the pod switches 1032 and 1036. The pod switches 1032 and 1036 can facilitate communication between the pods 1040 and 1044 and client machines communicably connected with the cloud 1004, for example via core switches 1020 and 1024. Also, the pod switches 1032 and 1036 may facilitate communication between the pods 1040 and 1044 and the database storage 1056. In some implementations, the load balancer 1028 can distribute workload between the pods 1040 and 1044. Balancing the on-demand service requests between the pods can assist in improving the use of resources, increasing throughput, reducing response times, or reducing overhead. The load balancer 1028 may include multilayer switches to analyze and forward traffic.

In some implementations, access to the database storage 1056 is guarded by a database firewall 1048. The database firewall 1048 can act as a computer application firewall operating at the database application layer of a protocol stack. The database firewall 1048 can protect the database storage 1056 from application attacks such as structure query language (SQL) injection, database rootkits, and unauthorized information disclosure. In some implementations, the database firewall 1048 includes a host using one or more forms of reverse proxy services to proxy traffic before passing it to a gateway router. The database firewall 1048 can inspect the contents of database traffic and block certain content or database requests. The database firewall 1048 can work on the SQL application level atop the TCP/IP stack, managing applications' connection to the database or SQL management interfaces as well as intercepting and enforcing packets traveling to or from a database network or application interface.

In some implementations, communication with the database storage 1056 is conducted via the database switch 1052. The multi-tenant database storage 1056 can include more than one hardware or software components for handling database queries. Accordingly, the database switch 1052 can direct database queries transmitted by other components of the on-demand database service environment (for example, the pods 1040 and 1044) to the correct components within the database storage 1056. In some implementations, the database storage 1056 is an on-demand database system shared by many different organizations as described above with reference to FIG. 8 and FIG. 9.

FIG. 10B shows a system diagram further illustrating example architectural components of an on-demand database service environment according to some implementations. The pod 1044 can be used to render services to a user of the on-demand database service environment 1000. In some implementations, each pod includes a variety of servers or other systems. The pod 1044 includes one or more content batch servers 1064, content search servers 1068, query servers 1082, file force servers 1086, access control system (ACS) servers 1080, batch servers 1084, and app servers 1088. The pod 1044 also can include database instances 1090, quick file systems (QFS) 1092, and indexers 1094. In some implementations, some or all communication between the servers in the pod 1044 can be transmitted via the switch 1036.

In some implementations, the app servers 1088 include a hardware or software framework dedicated to the execution of procedures (for example, programs, routines, scripts) for supporting the construction of applications provided by the on-demand database service environment 1000 via the pod 1044. In some implementations, the hardware or software framework of an app server 1088 is configured to execute operations of the services described herein, including performance of the blocks of various methods or processes described herein. In some alternative implementations, two or more app servers 1088 can be included and cooperate to perform such methods, or one or more other servers described herein can be configured to perform the disclosed methods.

The content batch servers 1064 can handle requests internal to the pod. Some such requests can be long-running or not tied to a particular customer. For example, the content batch servers 1064 can handle requests related to log mining, cleanup work, and maintenance tasks. The content search servers 1068 can provide query and indexer functions. For example, the functions provided by the content search servers 1068 can allow users to search through content stored in the on-demand database service environment. The file force servers 1086 can manage requests for information stored in the File force storage 1098. The File force storage 1098 can store information such as documents, images, and basic large objects (BLOBs). By managing requests for information using the file force servers 1086, the image footprint on the database can be reduced. The query servers 1082 can be used to retrieve information from one or more file storage systems. For example, the query system 1082 can receive requests for information from the app servers 1088 and transmit information queries to the NFS 1096 located outside the pod.

The pod 1044 can share a database instance 1090 configured as a multi-tenant environment in which different organizations share access to the same database. Additionally, services rendered by the pod 1044 may call upon various hardware or software resources. In some implementations, the ACS servers 1080 control access to data, hardware resources, or software resources. In some implementations, the batch servers 1084 process batch jobs, which are used to run tasks at specified times. For example, the batch servers 1084 can transmit instructions to other servers, such as the app servers 1088, to trigger the batch jobs.

In some implementations, the QFS 1092 is an open source file storage system available from Sun Microsystems® of Santa Clara, Calif. The QFS can serve as a rapid-access file storage system for storing and accessing information available within the pod 1044. The QFS 1092 can support some volume management capabilities, allowing many disks to be grouped together into a file storage system. File storage system metadata can be kept on a separate set of disks, which can be useful for streaming applications where long disk seeks cannot be tolerated. Thus, the QFS system can communicate with one or more content search servers 1068 or indexers 1094 to identify, retrieve, move, or update data stored in the network file storage systems 1096 or other storage systems.

In some implementations, one or more query servers 1082 communicate with the NFS 1096 to retrieve or update information stored outside of the pod 1044. The NFS 1096 can allow servers located in the pod 1044 to access information to access files over a network in a manner similar to how local storage is accessed. In some implementations, queries from the query servers 1082 are transmitted to the NFS 1096 via the load balancer 1028, which can distribute resource requests over various resources available in the on-demand database service environment. The NFS 1096 also can communicate with the QFS 1092 to update the information stored on the NFS 1096 or to provide information to the QFS 1092 for use by servers located within the pod 1044.

In some implementations, the pod includes one or more database instances 1090. The database instance 1090 can transmit information to the QFS 1092. When information is transmitted to the QFS, it can be available for use by servers within the pod 1044 without using an additional database call. In some implementations, database information is transmitted to the indexer 1094. Indexer 1094 can provide an index of information available in the database 1090 or QFS 1092. The index information can be provided to file force servers 1086 or the QFS 1092.

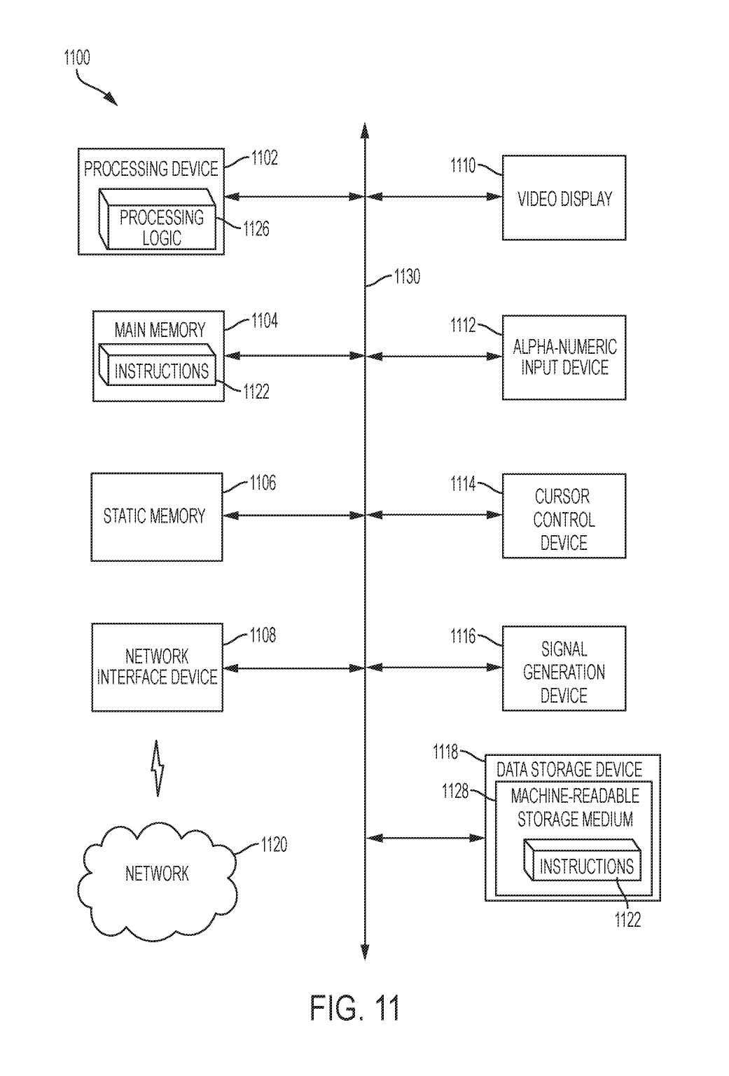

FIG. 11 illustrates a diagrammatic representation of a machine in the exemplary form of a computer system 1100 within which a set of instructions, for causing the machine to perform any one or more of the methodologies discussed herein, may be executed. The system 1100 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processing device (processor) 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)), and a data storage device 1118, which communicate with each other via a bus 1130.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like.

The computer system 1100 may further include a network interface device 1108. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1116 (e.g., a speaker).

The data storage device 1118 may include a computer-readable medium 1128 on which is stored one or more sets of instructions 1122 (e.g., instructions of in-memory buffer service 114) embodying any one or more of the methodologies or functions described herein. The instructions 1122 may also reside, completely or at least partially, within the main memory 1104 and/or within processing logic 1126 of the processing device 1102 during execution thereof by the computer system 1100, the main memory 1104 and the processing device 1102 also constituting computer-readable media. The instructions may further be transmitted or received over a network 1120 via the network interface device 1108.

While the computer-readable storage medium 1128 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for determining relevant priming data for an application and providing the relevant priming data to the application, comprising:
receiving, at an Intelligent Priming Module (IPM), input parameters associated with a user system and with a particular user of the user system;
monitoring for occurrence of a priming trigger event at a trigger module of the IPM;
processing the input parameters, at a prediction engine of the IPM in response to the occurrence of the priming trigger event, to determine relevant priming data that is predicted to be relevant to the particular user based on one or more of the input parameters;
pre-populating a cache with at least some of the relevant priming data;
loading the relevant priming data from the cache to a processor in response to another trigger event; and
executing the application at the processor to present the relevant priming data at a user interface of the user system in response to executing the application.

2. The method of claim 1, further comprising:
ranking, at a ranking module of the IPM based on one or more of the input parameters, the relevant priming data according to an order of priority that indicates relative importance to the user, and wherein pre-populating comprises:
pre-populating the cache with at least some of the relevant priming data ranked according to the order of priority.

3. The method of claim 1, wherein processing the input parameters, at a prediction engine of the IPM in response to the occurrence of the priming trigger event, to determine relevant priming data that is predicted to be relevant to the particular user based on one or more of the input parameters, comprises:
determining, based on the input parameters, a current profile that is personalized for the particular user and the user system;
loading a plurality of regression models that are associated with the current profile;
selecting one or more of the regression models for the particular user and the user system in view of one or more of the input parameters; and
apply the input parameters to the selected regression model to predict the relevant priming data that is predicted to be relevant to the particular user and the user system.

4. The method of claim 3, further comprising:
updating, using one or more machine learning processes, the one or more selected regression models based on the current profile and relevant priming data.

5. The method of claim 1, wherein the input parameters comprise one or more of:
constraint information that describes constraints of the user system, wherein the constraint information comprises one or more of: available memory resources of the user system, processing resources of the user system, number of applications currently running at the user system, amount of memory available per application of the user system, and information regarding network connectivity of the user system including currently available bandwidth and latency; and
intelligence information about the user system, wherein the intelligence information comprises one or more of: operating mode of the user system including an indication of being in airplane mode; status of the user system, information about current network connections of the user system including an indication of being in offline mode, information that describes one or more of: past locations of the user system at certain times, a current location of the user system, or planned future locations of the user system at certain times.

6. The method of claim 1, wherein the input parameters comprise one or more of:
user customer relationship management (CRM) information accessed from a CRM system, wherein the CRM information comprises records for any type of object;
user schedule information associated with the particular user of the user system, wherein the user schedule information comprises any information describing a past schedule event, a present schedule event or future schedule event of the particular user of the user system, and wherein the user schedule information is provided from one or more calendar applications associated with the particular user of the user system; and
habits information that indicate one or more habits of the particular user of the user system, wherein each habit is a regular practice that has a consistent pattern during a specific time frame, and wherein the habits information includes one or more of: information obtained from an application that indicates usage of that application by the particular user during the specific time frame; information obtained from a calendar application that indicates an event that the particular user is involved with during the specific time frame; and information obtained from records for objects maintained by the CRM system.

7. The method of claim 1, wherein the input parameters comprise one or more of:
user goal information associated with a goal that the particular user of the user system is working on over a period of time, wherein the user goal information describes a targeted task to be accomplished over the period of time;
social media reference information extracted by an agent implemented in conjunction with a social media application, wherein the social media reference information comprises information extracted from social media feeds of the social media application or from posts made in the social media application, wherein the social media reference information comprises one or more of: a social media handle or other tagging information that identifies the particular user; a topic of a post that includes the particular user; and social media handles or other tagging information from a post by the particular user that identify other people or groups; and
relevant priming data provided from other complimentary applications associated with the user system, wherein the other complimentary applications comprise: partner applications that leverage an application platform that provides the application.

8. The method of claim 1, wherein the application is served to the user system by a cloud-based application platform, wherein the priming data includes records each having an object type, and wherein the records are associated with any type of object.

9. The method of claim 1, wherein the IPM is implemented at one or more of: the user system and a server system that is configured to communicate with the user system via a network interface configured to provide connectivity to a network, and
further comprising:
retrieving, via the IPM, the relevant priming data from storage that is configured to store data for the application, wherein the storage is implemented at one of: the user system and the server system; and
wherein executing the application is implemented at one of: the user system and the server system.

10. A system, comprising:
storage configured to store data;
a user system comprising: a user interface;
a processing system that is configured to provide an application;
a cache configured to store relevant priming data;
an Intelligent Priming Module (IPM) configured to determine relevant priming data for priming the application, wherein the IPM comprises:
an agent module configured to receive input parameters associated with the user system and with a particular user of the user system;
a trigger module configured to monitor for occurrence of a priming trigger event;
a prediction engine configured to: process the input parameters, in response to the occurrence of the priming trigger event, to determine the relevant priming data that is predicted to be relevant to the particular user based on one or more of the input parameters;
wherein the processing system is configured to: pre-populate the cache with at least some of the relevant priming data; load the relevant priming data stored at the cache in response to another trigger event; and execute the application; and
wherein the user interface of the user system is configured to present the relevant priming data upon execution of the application.

11. The system of claim 10, wherein the IPM further comprises:
a ranking module configured to rank, based on one or more of the input parameters, the relevant priming data according to an order of priority that indicates relative importance to the user,
wherein the processing system is configured to: pre-populate cache with at least some of the relevant priming data ranked according to the order of priority.

12. The system of claim 10, wherein the prediction engine is further configured to:
determine, based on the input parameters, a current profile that is personalized for the particular user and the user system;
load a plurality of regression models that are associated with the current profile;
select one or more of the regression models for the particular user and the user system in view of one or more of the input parameters; and
apply the input parameters to the selected regression model to predict the relevant priming data that is predicted to be relevant to the particular user and the user system.

13. The system of claim 12, wherein the prediction engine is further configured to:
update, using one or more machine learning processes, the one or more selected regression models based on the current profile and relevant priming data.

14. The system of claim 10, wherein the input parameters comprise one or more of:
constraint information that describes constraints of the user system, wherein the constraint information comprises one or more of: available memory resources of the user system, processing resources of the user system, number of applications currently running at the user system, amount of memory available per application of the user system, and information regarding network connectivity of the user system including currently available bandwidth and latency; and
intelligence information about the user system, wherein the intelligence information comprises one or more of: operating mode of the user system including an indication of being in airplane mode; status of the user system, information about current network connections of the user system including an indication of being in offline mode, information that describes one or more of: past locations of the user system at certain times, a current location of the user system, or planned future locations of the user system at certain times.

15. The system of claim 10, wherein the input parameters comprise one or more of:
user customer relationship management (CRM) information accessed from a CRM system, wherein the CRM information comprises records for any type of object;
user schedule information associated with the particular user of the user system, wherein the user schedule information comprises any information describing a past schedule event, a present schedule event or future schedule event of the particular user of the user system, and wherein the user schedule information is provided from one or more calendar applications associated with the particular user of the user system; and
habits information that indicate one or more habits of the particular user of the user system, wherein each habit is a regular practice that has a consistent pattern during a specific time frame, and wherein the habits information includes one or more of: information obtained from an application that indicates usage of that application by the particular user during the specific time frame; information obtained from a calendar application that indicates an event that the particular user is involved with during the specific time frame; and information obtained from records for objects maintained by the CRM system.

16. The system of claim 10, wherein the input parameters comprise one or more of:
user goal information associated with a goal that the particular user of the user system is working on over a period of time, wherein the user goal information describes a targeted task to be accomplished over the period of time;
social media reference information extracted by an agent implemented in conjunction with a social media application, wherein the social media reference information comprises information extracted from social media feeds of the social media application or from posts made in the social media application, wherein the social media reference information comprises one or more of: a social media handle or other tagging information that identifies the particular user; a topic of a post that includes the particular user; and social media handles or other tagging information from a post by the particular user that identify other people or groups; and
relevant priming data provided from other complimentary applications associated with the user system, wherein the other complimentary applications comprise: partner applications that leverage an application platform that provides the application.

17. The system of claim 10, wherein the application is served to the user system by a cloud-based application platform, wherein the priming data includes records each having an object type, and wherein the records are associated with any type of object.

18. The system of claim 10, wherein the IPM is implemented at one or more of: the user system and a server system that is configured to communicate with the user system via a network interface configured to provide connectivity to a network, and
wherein the IPM is further configured to:
retrieve the relevant priming data from the storage that is configured to store data for the application, wherein the storage is implemented at one of: the user system and the server system; and
wherein the processing system that is configured to execute the application is implemented at one of: the user system and the server system.

19. A computing system, comprising:
a processor; and
a memory comprising computer-executable instructions that are capable of causing the computing system to:
receive input parameters associated with a user system and with a particular user of the user system;
process the input parameters, in response to occurrence of a priming trigger event, to determine relevant priming data that is predicted to be relevant to the particular user based on one or more of the input parameters;
pre-populate the cache with at least some of the relevant priming data,
wherein the processor is configured to: load the relevant priming data stored at the cache in response to another trigger event; and execute the application; and
a user interface configured to present the relevant priming data upon execution of the application.

20. The computing system of claim 19, wherein the computer-executable instructions are further capable of causing the computing system to:
rank, based on one or more of the input parameters, the relevant priming data according to an order of priority that indicates relative importance to the user, and pre-populate the cache with at least some of the relevant priming data ranked according to the order of priority.
